(19) United States
(12) Patent Application Publication
(10) Pub. No.: US 2010/0017225 A1
(43) Pub. Date: Jan. 21, 2010

(54) DIAGNOSTICIAN CUSTOMIZED MEDICAL DIAGNOSTIC APPARATUS USING A DIGITAL LIBRARY

(75) Inventors: David Oakley, Boulder, CO (US); Michael Hickey, Boulder, CO (US)

Correspondence Address: PATTON BOGGS LLP, 1801 CALFORNIA STREET, SUITE 4900, DENVER, CO, 80202, US

(73) Assignee: WAVi, Boulder, CO (US)

(21) Appl. No.: 12/567,249

(22) Filed: Sep. 25, 2009

Related U.S. Application Data
(63) Continuation-in-part of application No. 12/505,185, filed on Jul. 17, 2009.
(60) Provisional application No. 61/082,008, filed on Jul. 18, 2008.
(60) Provisional application No. 61/082,015, filed on Jul. 18, 2008.

(51) Int. Cl. G06Q 50/00

(52) U.S. Cl. 705/2

(57) ABSTRACT

The Customized Medical Diagnostic Apparatus operates under the control of a physician to implement a patient-specific instance of the apparatus by identifying medical information sources, retrieved from a Digital Library, which correlate to anomalies identified in a set of patient medical data relating to an identified patient or identified class of patient. The system includes a Digital Library for providing access to a plurality of information sources which relate to interpreting patient medical data and possible ailments associated with the patient medical data. A data characterization module calculates control variations of a set of patient medical data to identify anomalies. Based upon this statistical analysis, a Digital Library interface module searches the Digital Library for information sources relating to the set of patient medical data and interpretations of the identified anomalies.

### CROSS-REFERENCE TO RELATED APPLICATIONS

This application is a continuation of U.S. patent application Ser. No. 12/505,185 filed on Jul. 17, 2009, which application claims the benefit of U.S. Provisional Application No. 61/082,008 filed on Jul. 18, 2008 and U.S. Provisional Application No. 61/082,015 filed on Jul. 18, 2008.

### FIELD OF THE INVENTION

This invention relates to medical diagnostic systems and, in particular, to a system that enables a physician to implement a patient-specific medical diagnostic tool which uses a Digital Library to provide medical and/or psychological data, which is correlated with patient data, to identify potential patient ailments or conditions.

### BACKGROUND OF THE INVENTION

There are numerous existing medical test and analysis systems, many of which are ailment-specific, for either generating patient test data for manual review by a treating physician or for analyzing collected patient test data to determine whether the patient suffers from a certain ailment or condition. These existing test and analysis systems are ailment-specific and simply process the collected patient data to provide the treating physician with a presentation of the data which can be interpreted by the treating physician to determine whether the patient suffers from the condition the test is designed to detect and/or whether the patient falls into predefined relevant risk groups. Some of the latest generations of medical devices have transitioned from basic physiological measurement (that requires a trained interpretation) to a formal ailment diagnosis. The deterministic approach of these medical devices appropriately requires significant regulatory oversight to ensure the reliability and validity of the technology and the accuracy of the formal ailment diagnosis. While these objective diagnoses produced by the medical devices represent significant commercial value, they come at significant cost with respect to time and costs of empirical clinical trials, including the risk of future contradictory or displacing research. In the case of a conflict between commercial diagnostics and new research, the community of diagnosticians is left with a less than optimal solution and is often presented with a profound uncertainty resulting in a stalled decision in patient point-of-care situations. In the end, rapid change in the associated medical science can produce paralysis when physicians suspect the automated ailment diagnoses are using outdated informational and analysis sources.

A problem with physician diagnosis of ailments is that the validity of the results obtained by using this process is predicated on the treating physician both having sufficient knowledge of the ailment and also being able to identify anomalies in the patient test data, which anomalies can be subtle indicators. Medical schools are traditionally responsible for training physicians on the diagnostic utility of physiological measurements, with more training required for measures that don't have a simple FDA-approved binary solution. This education rightfully focuses on historic studies that provide the interpretation of medical device and laboratory data. These interpretations rely on the integrity and transparency of peer-reviewed scientific journals and medical texts from which a physician would base their diagnostic and treatment decisions. The primary source for these materials (both in medical school and for practicing physicians) is public and private medical libraries, each of which supports a standard for the peer review and medical validity of their content. Research on new medical devices and diagnostic interpretation are added to these libraries daily, representing an explosion in the amount of scientific studies potentially relevant to physician's patient populations. Unfortunately for the general practitioners (and even specialists), the volume of new research is difficult to assimilate into the point of care without the context of a given patient measurement, and these results are often contradictory. Understanding that the ability to aggregate and interpret a variety of patient diagnostic measurements is the responsibility of the physician, there is a limit to the amount of raw data these highly trained professionals can integrate. Furthermore, there are little known ailments that manifest themselves in a manner that closely mimics other ailments, thereby making it difficult to diagnose these ailments, since the physician only sees patient symptoms and patient-specific test results.

A further problem is that there is a limitation in this process in that a human can only process a certain limited amount of data and the treating physician, no matter how skilled, can fail to identify the convergence of a number of trends in the patient test data or a collection of seemingly unrelated anomalies. This is especially true when there are a number of existing patient-specific test results, such as: past ailment-specific test results, present ailment-specific test results, test results directed to test for other ailments, patient demographic and physical data, including the patient's history of medications, and the like.

Thus, there is presently no system which enables the treating physician to effectively monitor and process multiple sets of patient data and customize the analysis of this collected patient-specific data for the individual patient to cover ailments as specified by the physician (or unspecified), all in conjunction with the ability to dynamically access a Digital Library which provides the treating physician with resource materials, including control and control data sets for patients.

### BRIEF SUMMARY OF THE INVENTION

The above-described problems are solved and a technical advance achieved by the present Diagnostician Customized Medical Diagnostic Apparatus Using A Digital Library (termed “Customized Medical Diagnostic Apparatus” herein) which enables the treating physician to monitor multiple sets of patient data and customize, using patient or group specific customization, the analysis of this collected patient-specific data for the individual patient to cover multiple ailments, all in conjunction with a Digital Library which provides the treating physician with resource materials, including control data sets for patients.

In this description, the term “physician” (also termed “diagnostician” or “clinician”) is intended to include anyone who performs a diagnostic function, to review data about a patient, and correlate that data with known ailments to provide the patient with a diagnosis of their present state of health. In addition, the term “ailment” is used in the general sense to represent any medical or psychological or physiological condition or problem that affects, or may in the future affect, a patient, whether or not it is life or health threatening.

The Customized Medical Diagnostic Apparatus operates under the control of a physician to implement a patient-specific instance of the apparatus by identifying medical information sources (also termed “published literature” herein), retrieved from a Digital Library, which correlate to anomalies identified in a set of patient medical data relating to an identified patient or identified class of patient. This apparatus includes a Digital Library for providing access to a plurality of information sources which relate to interpreting patient medical data and possible ailments associated with patient medical data, as well as a data characterization module for calculating control variations of a set of patient medical data collected from and about an identified patient, with patient medical data of a base set of control data to identify anomalies in a set of patient medical data. Furthermore, the Customized Medical Diagnostic Apparatus includes a Digital Library interface module, which responds to receipt of the set of patient medical data collected from and about an identified patient as well as identified anomalies calculated by the data characterization module relating to the set of patient medical data, by searching the Digital Library with physician-defined search criteria to locate information sources relating to the set of patient medical data and interpretations of the identified anomalies calculated by the data characterization module relating to the set of patient medical data. An information access module provides an authorized physician with access to the information sources returned by the Digital Library interface module and relating to the set of patient medical data.

The Customized Medical Diagnostic Apparatus can also access shared databases which serve a group of physicians and health care facilities to enable the physician to retrieve multiple sets of patient data as well as to accumulate point-of-care knowledge in a quickly-expanding medical-discovery environment. The physician not only can interpret medical data to provide an improved diagnosis of existing and/or future ailments by accessing the Digital Library, but also can put this data back into the system for further analysis. The patient-specific data can be configured into a patient anonymous form for this purpose to enable other physicians to benefit from the data without infringing on the privacy of the patient. The Customized Medical Diagnostic Apparatus thereby creates a medical-advancement environment—the library takes patient/physician data from multiple sources including outcomes, incorporates all data into new knowledge, and puts the information back to the physicians at a point-of-care locus.

An additional benefit of the Customized Medical Diagnostic Apparatus is that the discovery of an outcome need not be linked to a predetermined physician defined hypothesis—all the data is parameterized, and the parameters are allowed to “wander”, where parameters are tested as correlations against the existing environment of all known medical outcomes. In this paradigm, the successful correlations survive as new medical discoveries which couple symptoms and/or anomalies and/or test data to an ailment. This is especially pertinent in the situation where little known ailments are present and the physician-defined hypothesis could inadvertently exclude these little known ailments due to the physician unknowingly biasing the analysis.

Thus, the Customized Medical Diagnostic Apparatus provides diagnostic capabilities heretofore unknown in the medical profession by linking a Digital Library to the physician and patient-specific data as defined and moderated by the physician.

### BRIEF DESCRIPTION OF THE DRAWINGS

FIG. 1 is a block diagram of the present Customized Medical Diagnostic Apparatus and an environment in which it is operational;

FIG. 2 is a block diagram illustrating the components of the Digital Library;

FIG. 3 is a block diagram illustrating the components of the Physician Application;

FIG. 4 is a flow chart illustrating operations for setting up or updating a Physician Application interface customization;

FIG. 5 is a block diagram illustrating the components of the Analysis Platform;

FIG. 6 is a flow chart illustrating a set of operations for generating a Control Database;

FIG. 7 is a flow chart illustrating a set of operations for generating a Correlative Database;

FIG. 8 is a flow chart illustrating a set of operations for generating a Patient Database;

FIG. 9 is a flow chart illustrating a set of operations for generating a Trait Scale Index;

FIG. 10 is a flow chart illustrating a set of operations for generating a Diagnostic Index;

FIG. 11 is a flow chart illustrating a set of operations for generating a Treatment Index;

FIG. 12 is a flow chart illustrating a set of operations for generating a Predictive Index;

FIG. 13 is a flow chart illustrating a set of operations for digitizing and processing published information for inclusion into the Digital Library;

FIG. 14 is a flow chart illustrating a set of operations for updating databases and/or indexes;

FIG. 15 is a flow chart illustrating an example of a set of operations used to assist in patient test data interpretation;

FIG. 16 is a diagram illustrating an example EEG electrode placement for gathering EEG data;

FIGS. 17A and 17B illustrate an example of EEG data that may be gathered during an EEG test;

FIG. 18 is a patient test flowchart;

FIG. 19 is a block diagram of an implementation of the Biological/Physiological Measurement Device;

FIG. 20A is a screen shot of EEG data presented in a spectral array;

FIG. 20B is a screen shot of topographic maps of the raw EEG data;

FIG. 21A illustrates a screen shot showing a compressed spectral array of raw EEG data;

FIG. 21B illustrates a screen shot of a trend analysis of the raw EEG data;

FIG. 22 is an example of a control reference database comparison using coherence z-scores;

FIG. 23 is a flow chart with a set of operations for generating a statistical analysis;

FIG. 24 is a screen shot of an example physician interface;

FIG. 25 is a flow chart with an example of a set of operations to update a predictive index; and

FIG. 26 is a flow chart showing the use of the various indexes in the course of a patient examination.

### DETAILED DESCRIPTION OF THE INVENTION

The Customized Medical Diagnostic Apparatus operates under control of a physician to implement a specific instance of the apparatus which automatically identifies medical information sources which correlate to anomalies identified in a set of patient medical data relating to an identified patient or class of patients. The system includes a Digital Library for providing access to a plurality of information sources which relate to interpreting patient medical data and possible ailments associated with the patient medical data. A data characterization module calculates control variations of a set of patient medical data to identify anomalies. Based upon this statistical analysis, a Digital Library interface module searches the Digital Library for information sources relating to the set of patient medical data and interpretations of the identified anomalies. There is also an information access module which provides an authorized person, such as a physician, with access to the information sources returned by the Digital Library interface module and relating to this set of patient medical data. The physician can use this information at the point of care on an identified patent, on all patients, or a class of patients according to the level of automation built by that physician.

System Architecture—Customized Medical Diagnostic Apparatus

Communication Environment

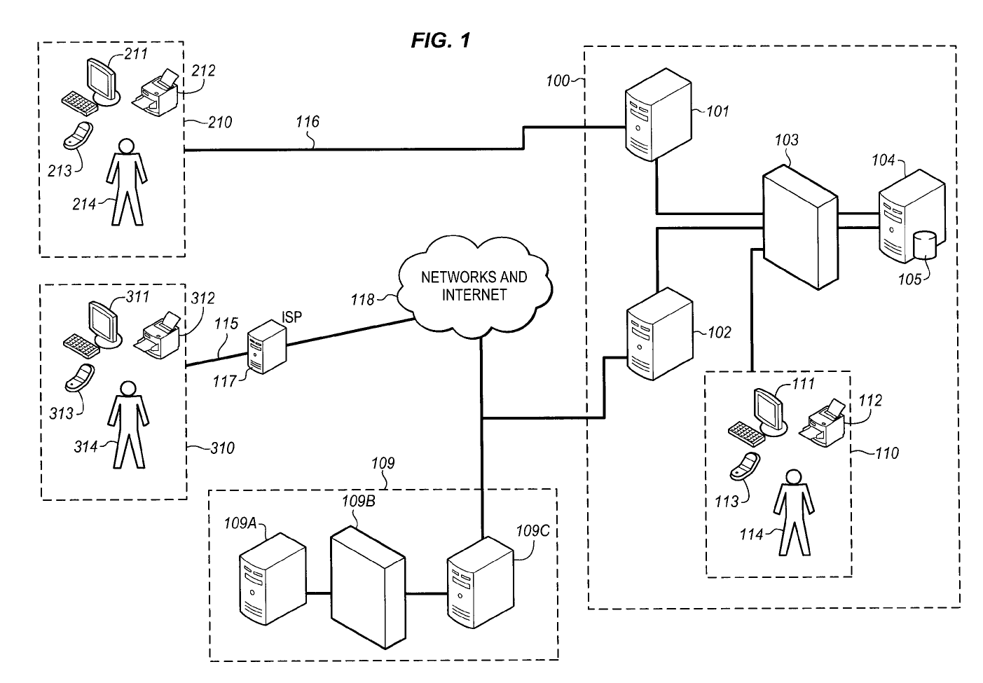

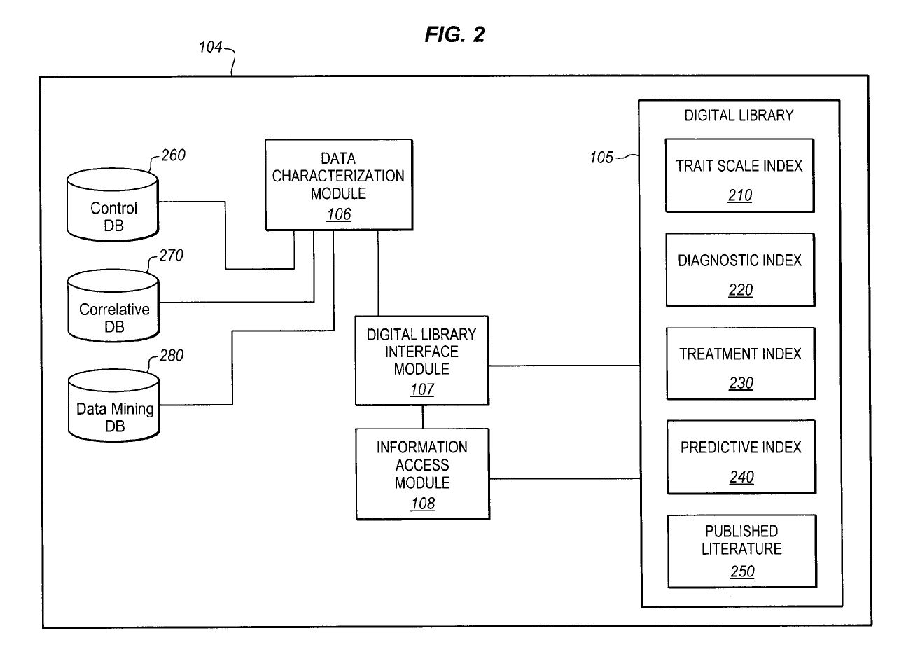

FIG. 1 is a block diagram of the present Customized Medical Diagnostic Apparatus and an environment in which it is operational. In particular, the communications environment is adaptable and a physician 314 who is equipped with at least one electronic device (such as computer 311, printer/fax/scanner 312, cell phone 313, and the like—collectively termed “physician equipment 310”) can be connected via a communication medium 115 (such as wire line, cable television, satellite, cellular, and the like) to an Internet Service Provider (ISP) 117 which interconnects the physician with a data communication network 118 (termed “Internet” herein) and thence to the Customized Medical Diagnostic Apparatus 100. Alternatively, physician 214 who is equipped with at least one electronic device (such as computer 211, printer/fax/scanner 212, cell phone 213, and the like—collectively termed “physician equipment 210”) can be directly connected via a communication medium 116 (such as wire line, cable television, satellite, cellular, and the like) to the Customized Medical Diagnostic Apparatus 100. A final configuration is physician 114 who is equipped with at least one electronic device (such as computer 111, printer/fax/scanner 112, cell phone 113, and the like—collectively termed “physician equipment 110”) is directly connected “on-site” to the present Customized Medical Diagnostic Apparatus 100. These configurations are exemplary, and the following description is directed to the functionality provided by the Customized Medical Diagnostic Apparatus 100, which operates independent of the access architecture which is used.

Customized Medical Diagnostic Apparatus

The Customized Medical Diagnostic Apparatus 100 operates one or more Database Servers 104 to provide a secure environment for the storage and processing of data associated with the applications described herein. The Database Servers 104 (also referred to as “databases”) can be implemented by a cluster of servers and interface with the Digital Library 105 which serves to store mass quantities of medical information as described below. A Firewall 103 is also provided to prevent access to the Database Server 104 except for the authorized applications. The interface server 101 and the WEB server 102 respond to requests from browsers and process the request and store and retrieve data on the associated Database Server 104 as required.

The Customized Medical Diagnostic Apparatus 100 includes a Digital Library 105 for providing access to a plurality of information sources which relate to interpreting patient medical data and possible ailments associated with patient medical data, as well as a Data Characterization Module 106 for calculating control variations of a set of patient medical data collected from and about an identified patient with patient medical data of a base set of control data to identify anomalies in a set of patient medical data. Furthermore, the Customized Medical Diagnostic Apparatus 100 includes a Digital Library Interface Module 107, which responds to receipt of the set of patient medical data collected from and about an identified patient as well as identified anomalies calculated by the Data Characterization Module 106 relating to the set of patient medical data, by searching the Digital Library 105 for information sources relating to the set of patient medical data and interpretations of the identified anomalies calculated by the Data Characterization Module 106 relating to the set of patient medical data. The Digital Library Interface Module 107 also contains physician selected bio-markers, ailment characteristics, search criteria and rules engines that highlight conditions of particular concern to the physician. An Information Access Module 108 provides an authorized physician with access to the information sources returned by the Digital Library Interface Module 107 and relating to the set of patient medical data.

In addition to Digital Library 105, the physician can have access to shared medical records which reside on Medical Record Database 109. The Medical Record Database 109 can be a database shared among a plurality of physicians and health care facilities which serve a region or patient population. As is the norm, access to the Customized Medical Diagnostic Apparatus 100 and Medical Records Database 109 is regulated to admit only authorized personnel via a secure access protocol as is known in the art. The Medical Records Database 109 includes a WEB server 109C, a Firewall 109B, and the Records Database 109A.

Database Server

Database Server 104 consists of the processing engine which executes the processes described herein and which manages access to the Digital Library 105 and the various databases 260-280. In this regard, Control Database 260 contains control (typically normal) data sets for subject data. This data comprises sets of data which represent the control measurement data of various characteristics of subjects that are taken from readings on various subjects, with the data typically being parsed by subject category and subject characteristics as is well known in the art. Correlative Database 270 consists of the results of correlating patient-specific data with selected data sets contained in the Control Database 260. The correlation data represents detected anomalies which can be used by the treating physician to identify one or more ailments which affect the patient. This correlation data can be tied to a resultant diagnosis and treatment methodology (with follow-up data indicative of results or successive correlation results) and can be shared among physicians to enable other physicians to benefit from these results. The patient data is anonomized to ensure privacy of the patient, with typically only the relevant patient physical, socioeconomic, psychological, and demographic data being tied to the results. Data Mining Database 280 consists of the analysis data which are generated by physicians using the Customized Medical Diagnostic Apparatus 100 and represent the results of data and literature analysis operations (past searches and analyses) performed by physicians. The Data Mining data, therefore, is the log of experiential information that is shared on a peer-to-peer basis by the physicians who access the Customized Medical Diagnostic Apparatus 100.

Thus, there are two aspects of the Customized Medical Diagnostic Apparatus 100 which should be noted here. The first aspect is the patient-agnostic repository of relevant published literature 250 and indices 210-250 stored in the Digital Library 105, which are representative of the resources available to the physicians to use in their various diagnostic processes as well as for their general professional education. The second aspect of the Customized Medical Diagnostic Apparatus 100 is the sets of data stored in the databases 260-280, representative of physician-generated and controlled information which is either patient-specific or control in nature. The physician generates the search strategies, analysis tools, correlation steps, and data mining operations to produce a patient-specific analysis, treatment, and ongoing care management regimen. Thus, this second aspect is representative of both physician-specific and peer-to-peer research and analysis results which collectively enhance the knowledge set available to the physicians who use the Customized Medical Diagnostic Apparatus 100 in their practices.

Digital Library

The Digital Library 105 contains digitized information (Published Literature 250) such as books, scientific research, manuscripts, videos, audio files, etc., that can be used by the physician to research ailments, conditions, and other related information. The Digital Library 105 can also include a plurality of indices, such as: a Trait Scale Index 210, a Diagnostic Index 220, a Treatment Index 230, and/or a Predictive Index 240 that can aid a physician in explaining possible interpretations of patient data and making improved diagnoses. These indices contain data relations that enable the physician to statistically compare patient-specific test results to a base group of control subjects to obtain correlation data which indicate the probability of the presence of a particular psychological or physiological ailment or condition in the patient.

Trait Scale Index 210 is a collection of data relations and possibly distributions of those data relations as found in members of the control database that have been identified from literature.

Diagnostic Index 220 is a set of data relations that have been correlated with diagnoses from a physician. These correlations are developed based on data accessed through the aggregated patient database stored in Data Mining Database 270. Diagnostic Index 220 may also include distributions of the data relations and may also be computed information of control subject data found in Control Database 260. Out-of-variance data relations found during the statistical analysis can be searched for in Diagnostic Index 220 in order to aid a physician in determining the ailment of a patient.

Treatment Index 230 is a collection of data relating to treatments which have proven effective for patients with similar statistical characterizations of the collected patient data.

Predictive Index 240 includes a set of data relations that have been correlated between earlier collected patient data and a current diagnosis from a physician. For example, a patient may go to a physician and have routine medical tests performed throughout his lifetime. In his seventies, he takes a medical test and is diagnosed with Alzheimer's. Predictive Index 240 is created by generating correlations between this and other patients' earlier test data and the current diagnosis of Alzheimer's to find early indicators.

Digital Library 105 has access to multiple publications or other types of Published Literature 250 relating to interpreting medical data and possible ailments associated with medical data. Examples of the types of publications and published information stored in or accessible to the Digital Library include, but are not limited to: books, scientific research articles, scientific research manuscripts, videos, audio files, tables, and/or summaries of published information, desk references, and the like.

Digital Library 105 can also store Physician Applications which can be loaded directly into the digital terminals used by a physician as is described below. For example, a specialist in the field of depression could create a Physician Application that has data relations the specialist would be interested in using during the statistical characterization of the relevant patient data.

Data Characterization Module

Data Characterization Module 106 is a process which typically executes on the Database Server 104 and which calculates control variations of a set of patient medical data collected from and about an identified patient with patient medical data of a base set of control data to identify anomalies in a set of patient medical data.

Digital Library Interface Module

Digital Library Interface Module 107 is a process which typically executes on the Database Server 104 and which responds to receipt of the set of patient medical data collected from and about an identified patient as well as identified anomalies calculated by the Data Characterization Module 106 relating to the set of patient medical data, by searching the Digital Library 105 for information sources relating to the set of patient medical data and interpretations of the identified anomalies calculated by the Data Characterization Module 106 relating to the set of patient medical data.

Information Access Module

Information Access Module 108 is a process which typically executes on the Database Server 104 and which provides an authorized physician with access to the information sources returned by the Digital Library Interface Module 107 and relating to the set of patient medical data.

Physician Application

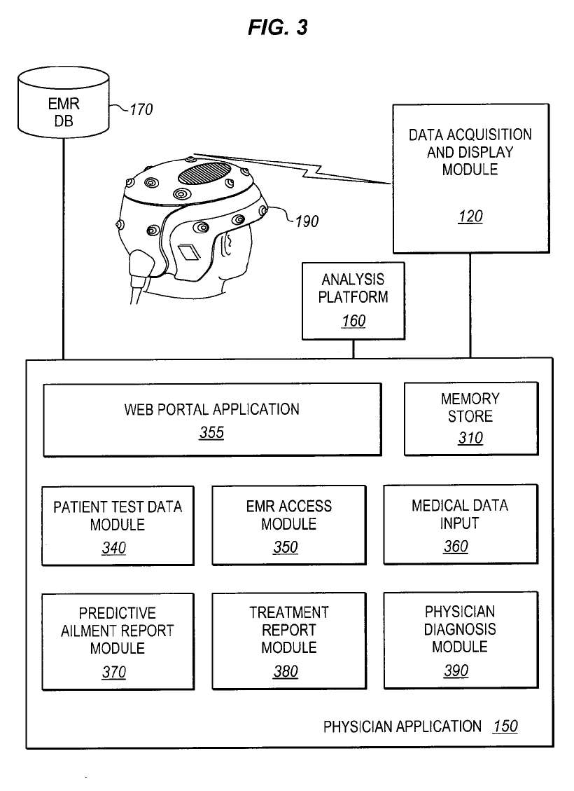

As noted above, the physicians access the Customized Medical Diagnostic Apparatus 100 either via Server 101 or via WEB portal server 102. The physicians' access is typically via a Physician Application 150 (shown in FIG. 3) which executes on a physician digital terminal 111, 211, 311. The Physician Application 150 consists of various processes which enable the communication with the above-noted elements of the Customized Medical Diagnostic Apparatus 100 and which enable the physician to view and generate reports and data output used in the diagnosis and treatment of the patient's ailments.

FIG. 3 is block diagram illustrating a typical Physician Application 150 which is executing an application to receive and process patient test data from and for a specific patient. The Physician Application 150 shown in FIG. 3 includes the following components: WEB Portal Application 335, Patient-Test-Data Module 340, Electronic Medical Records Access Module 350, Medical Data Input Module 360, Predicative Ailment Report Module 370, Treatment Report Module 380, and Physician Diagnosis Module 390. Memory Store 310 can have stored thereon local versions of a control database, a correlative database, a patient test database, and a data mining database.

Web Portal Application 355 may be used by Physician Application 150 to connect to the Customized Medical Diagnostic Apparatus 100. The Physician Application 150 can transfer patient data, such as: patient test data, data relations, medical data, and the like to the Customized Medical Diagnostic Apparatus 100 and receive reports and statistical characterization results from the Customized Medical Diagnostic Apparatus 100. Web Portal Application 335 is able to encrypt and decrypt the information that is being sent and received. Patient Test Data Module 340 provides an interface between the Data Acquisition and Display Module 120 and Physician Application 150. Patient Measurement Data Module 340 also translates any requests for more patient test data from the Physician Application 150 into a format required by the Customized Medical Diagnostic Apparatus 100 and translates and/or directs incoming requests and/or data to the appropriate module or application within the Physician Application 150. Patient Test Data Module 340 is a receiving module that is configured to receive sets of patient test data relating to a test subject and store the sets of patient test data in a patient test database.

Once patient test data is received through Patient Test Data Module 340, the data may be associated with sets of data received through Electronic Medical Records Access Module 350. Electronic Medical Records Access Module 350 provides an interface between Electronic Medical Records Databases 170 and Physician Application 150. Electronic Medical Records Access Module 350 translates any requests for electronic medical records from the Physician Application 150 into a format required by the destination component. Similarly, Electronic Medical Records Access Module 350 is able to translate and/or direct incoming requests (e.g., requests for passwords or other authentication) and/or data to the appropriate module or application within the Physician Application 150.

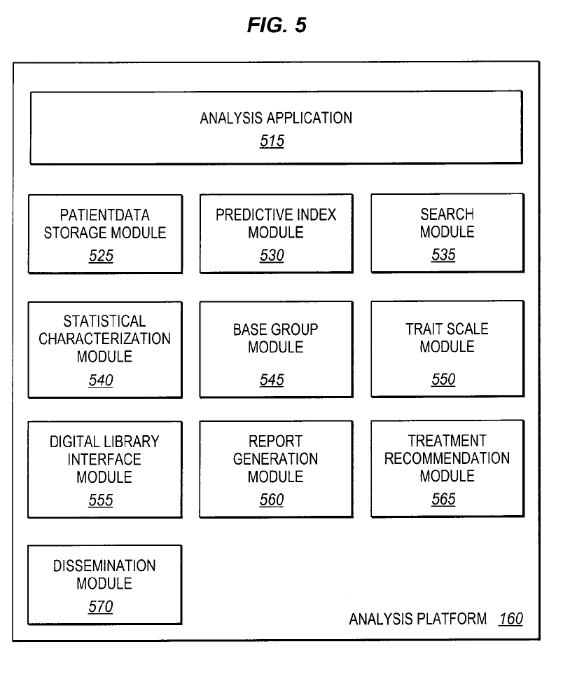

Predictive Ailment Report Module 370 and Treatment Report Module 380 interface with the Electronic Medical Records data of the patient, Storage Databases 170, and/or Analysis Platform 160 (shown in FIG. 5) to request information about current and past treatments and previously generated predictive ailment reports.

Physician Diagnosis Module 390 generates physician interface screen(s) that allow the physician to input a diagnosis. Physician Diagnosis Module 390 provides for the entry of a diagnosis, and Physician Diagnosis Module 390 can interface with the Analysis Platform 160 to generate a short list of diagnoses for the physician to choose from based on the results of the statistical characterization of the patient test data. If the physician likes one of those diagnoses, the physician can select it. If not, the physician is able to enter a different diagnosis through the physician interface screen options.

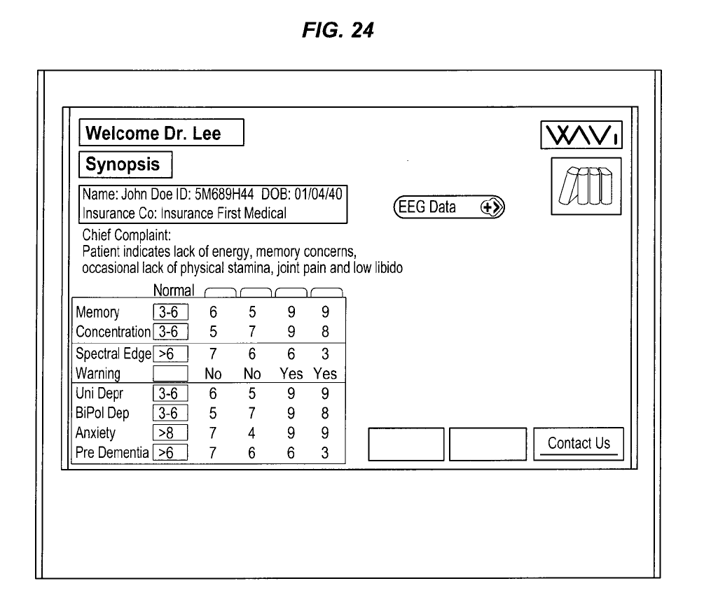

FIG. 24 is a screen shot of an example physician interface that may be used by the Physician Application to input and retrieve analysis data. This screen shot shows an example patient dashboard showing patient medical history (symptoms, descriptions, prescriptions, etc.) along with device measurements that were selected by the physician. This interface is customized by the physician and provides a click-through ability that provides the user of the invention access to the self-selected rules engine, in this case the supporting research of a given computation (i.e., Memory, Concentration, Anxiety, etc.).

Physician Application Setup

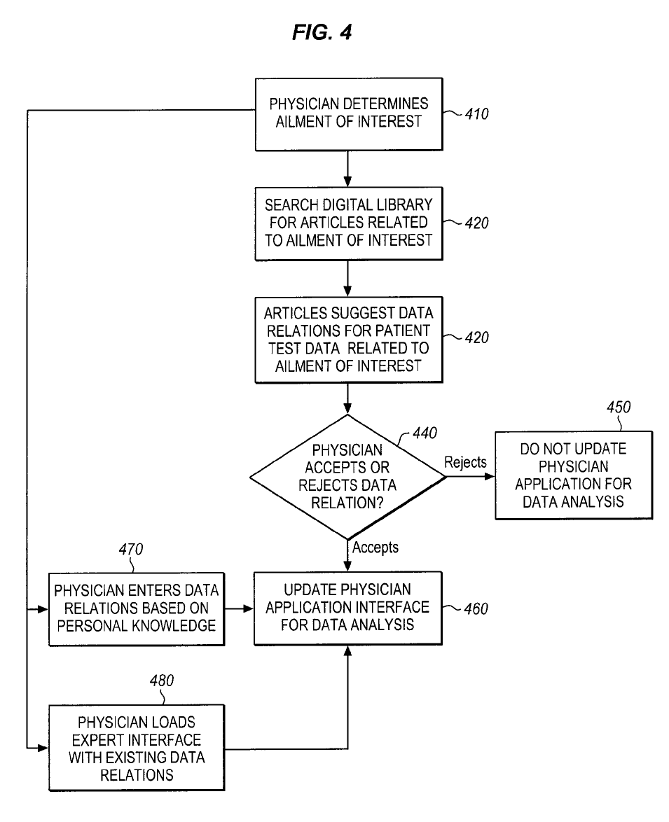

FIG. 4 is a flow chart illustrating operations for setting up or updating a Physician Application 150. In FIG. 4, a physician first determines an ailment or condition of interest at step 410. For example, when a patient arrives at a physician's office, the physician can make an initial assessment of the patient and determine that the patient may have a certain ailment or condition (e.g., depression). In other situations, the physician could have decided that he wants to screen all his patients for a certain ailment (e.g., attention deficit disorder). Still yet, selections of certain ailments could occur automatically. For example, the physician could select that all previous diagnoses in the patient's electronic medical records be retested and/or monitored.

Upon deciding ailment(s) of interest, the physician can set up (program) the Physician Application 150, or load a pre-existing interface setup, to determine if the patient test data is indicative of the ailment of interest. To this end, the physician also can access the Digital Library 105 and search at step 420 for the ailment of interest (e.g., depression). The search typically returns published literature which provides data relations at step 430 that, when statistically compared to a base group of control subjects, has been shown to indicate the ailment. The physician can review the published literature and decide at step 440 whether to accept or reject the data relations in a particular article. If the physician rejects the data relation, then the Physician Application 150 is not updated at step 450. In addition to searching for published literature which indicates data relations for a particular ailment, the physician can use personal knowledge about patient test data to set up data relations to be compared to the control group at step 470. Still yet, the physician can search for and load pre-designed expert interfaces with data relations that have been developed by experts in the field at step 480. Whether the physician selects data relations from the Digital Library 105, enters data relations based on personal knowledge, and/or accepts a pre-designed expert interface, the application interface is appropriately updated.

Analysis Platform

Analysis Platform 160, shown in FIG. 5, is a processor-based element which can be associated with the Physician Application 150 in the physician digital terminal 111, 211, 311, or in a separate but associated component, either accessible via the network or even implemented within server 104. FIG. 5 is a block diagram illustrating components that may be present in Analysis Platform 160: Analysis Application 515, Rules Engine 520, Data Storage Module 525, Predictive Index Module 530, Search Module 535, Statistical Characterization Module 540, Base Group Module 545, Trait Scale Module 550, Digital Library Interface Module 555, Report Generation Module 560, Treatment Recommendation Module 565, and Dissemination Module 570.

Data Storage Module 525 is configured to store the acquired patient test data as well as additional medical information and data relations. The Rules Engine 520 is constructed by the physician using components found in the Digital Library 105 and can also include rules generated by the physician. Using demographic information received from Physician Application 150, Base Group Module 545 is able to search the Control Database 260 and select distributions of control patient data that correspond to the demographics of the test subject. The physician is able to set the selection criteria through Physician Application 150.

Once patient test data, desired data relations, and the base group are received, Statistical Characterization Module 540 calculates control variations of the patient test data with measurement data of a base group selected from data in the Control Database 260. The selection of control data and distributions from Control Database 260 can be transferred back to Physician Application 150.

Once the statistical characterization of the patient's measurement data is completed, the results are communicated to Report Generation Module 560 which generates reports such as a treatment report, a predictive ailment report, and others. To generate a treatment report, Treatment Index 230 could be accessed and treatments associated with the results retrieved; and Treatment Recommendation Module 565 is used to automatically associate the control variations of the patient's measurement data with ailments. To this end, Treatment Recommendation Module 565 could be used to search informational vehicles in the Digital Library for treatment plans relating to the statistical characterization results. As another example, a treatment report could be generated based on keywords in the physician's diagnosis entered through Diagnostic Module 390 in Physician Application 150. Predictive Index Module 530 is configured to access the electronic medical records of the patient and build predictive indexes based on the acquired patient test data and information in the electronic medical records.

Search Module 535 is able to receive requests to search the Digital Library 105 for articles relating to a particular ailment or condition. Search Module 535 translates the request into the appropriate format and uses Digital Library Interface Module 555 to search the Digital Library 105 for published information relating to a particular ailment or condition. In addition to searching for published information in the Digital Library 105, Search Module 535 also can process the request and use Trait Scale Module 550 to search for data relations that have been correlated with the condition or ailment of interest.

### System Databases

Control Database

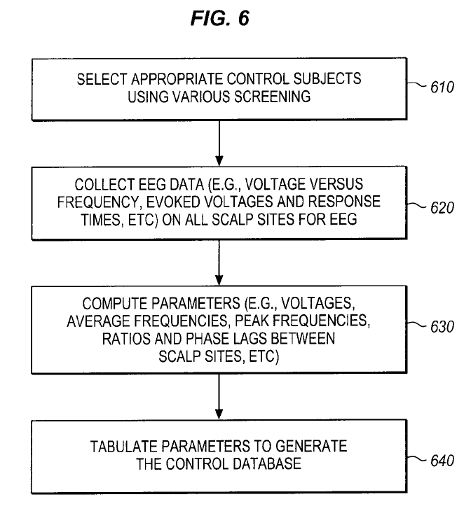

FIG. 6 is a flow chart illustrating a set of operations for generating a Control Database 260 (e.g. Normative data). Control Database 260 stores test data and/or distributions of test data features or parameters from a set of control individuals. At step 610, an individual (physician, researcher, etc.) determines a set of control individuals, which for EEG includes using health history questionnaires and/or psychometric screening. For example, a health history questionnaire may screen for people who have no head injuries, are not on any medications, have an absence of known ailments, and the like. A psychometric screening process can be used to screen out individuals with mental conditions (e.g., Axis I and Axis II disorders). In some cases, the selection could be performed using a clinical study. The clinical study could be designed to obtain mental function data from a set number of control, non-clinically impaired subjects by using physical, biological, and/or neuropsychological testing. To ensure reliable data for Control Database 260, the study design could include at least one interim assessment of the patient test data. In addition, the study population could be increased until consistent split-half replication is achieved. For example, Spearman-Brown's coefficient could be used to evaluate the association between split-half replications for each measure. Other possible study considerations include, but are not limited to, the inclusion/exclusion criteria to identify a control population, sufficient age coverage across the average lifespan (e.g., 18-90 years), sufficient artifact-free test data for analysis, and methodologies for standardization. Once the clinical study is completed, parallel partial correlation analysis could be used to eliminate any systematic effects of age, sex, and handedness.

Smaller clinical studies (e.g., N<20) could be used in conjunction with resampling methods, such as bootstrapping, to generate distributions of test data features and/or data relations. For example, a computer model of an approximating distribution, such as an empirical distribution of observed data, could be set up. The computer model could use bootstrapping methods to sample from the approximating distribution and allow for the estimation of statistical properties. One advantage of using bootstrapping methods is that the controlity assumption is not required.

Test data from control individuals then is collected at step 620 using Biological/Physiological Measurement Device 190 such as that shown in FIG. 3. In the case of EEG tests, the test data can be collected under eyes-closed resting conditions, eyes-closed auditory active conditions, and the like. Once a set of control EEG data is collected on all scalp sites from a variety of control individuals, EEG parameters are computed at step 630. Examples of EEG parameters which can be computed at step 630 include, but are not limited to, voltages, average frequencies, peak frequencies, ratios between scalp sites, phase lags between scalp sites, and the like.

Once the EEG parameters are computed, at step 640, the Customized Medical Diagnostic Apparatus 100 generates a Gaussian distribution of these features which then are stored in Control Database 260. Multiple Gaussian distributions of these features can be created using control individuals with similar characteristics, such as age ranges (e.g., 18 to 20, 21 to 30, 31 to 40, 41 to 50, etc.), right handedness, left handedness, native language, race, culture, gender, weight, height, smoking habits, alcohol consumption habits, use of non-medication supplements, use of hormone therapies, pregnancy testing (for female subjects), education level, hearing ability, vision, and the like. Each distribution can be tagged with metadata indicating the similar characteristics which were used to create the distribution. The metadata can be used later in searching Control Database 260 to find a Gaussian distribution created with characteristics similar to a current test subjects

Control Database 260 could also be validated using validation tests. The validation tests can be designed to test the following: controlity, culture-fairness, reliability, comparability to published replication, and an adequate demonstration of sensitivity and specificity.

Correlative Database

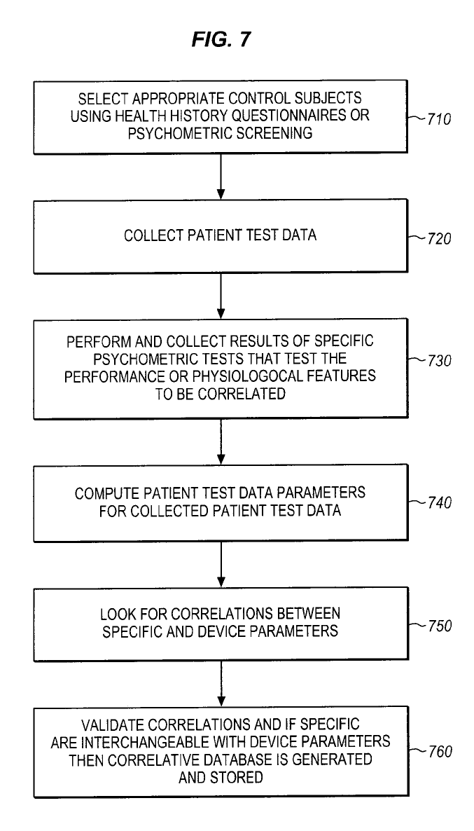

FIG. 7 is a flow chart illustrating a set of operations for generating a Correlative Database 270. Correlative Database 270 stores test data or Gaussian distributions of test data features or parameters from a set of control subjects. At step 710, an individual (physician or researcher) determines a set of control subjects, which in the case of EEG includes using health history questionnaires and/or psychometric screening. While not necessary, in many cases, the same individuals may be used for generating data for Control Database 260 and Correlative Database 270.

Test data from control individuals is collected at step 720. For example, EEG test data is collected under eyes-closed resting conditions for a period of ten minutes. Then, eyes-closed auditory active EEG data is collected in the presence of an auditory stimulus for ten minutes. The auditory stimulus can be a standard oddball task, where the subject is randomly presented with a series of high frequency tones. Instructions can be presented and the subject instructed to press a button with the index finger of each hand in response to the high target tones and to ignore the lower tones. The amount of EEG data and conditions under which the collection of the EEG data is collected can vary in different patients.

At step 730, in the example of EEG, the control subjects take a battery of neuropsychological tests to measure memory, concentration, and mental flexibility. The neuropsychological tests typically consist of the following: Digit Span and Letter-Number Sequencing Tests from the WMS-III to measure memory; the CPT-II to measure concentration; the WCST to measure mental flexibility; and the Stroop Task to confirm mental flexibility and concentration. However, other tests known to those of ordinary skill in the art may be used. In some cases, these tests are administered by a trained clinician to ensure that test subject fatigue does not affect the tests results.

Once a set of control test data is collected on all scalp sites from a variety of control individuals, test data parameters are computed at step 740. For EEG this includes: voltages, average frequencies, peak frequencies, ratios between scalp sites, phase lags between scalp sites, and the like. The neuropsychological test results are collected and the EEG data is processed. At step 750, Customized Medical Diagnostic Apparatus 100 then determines correlations between the test results and EEG parameters. The correlations between the test results and the EEG parameters are validated (e.g., using information in Data Mining Database 280) and recorded in Correlative Database 270 at step 760.

Patient Database

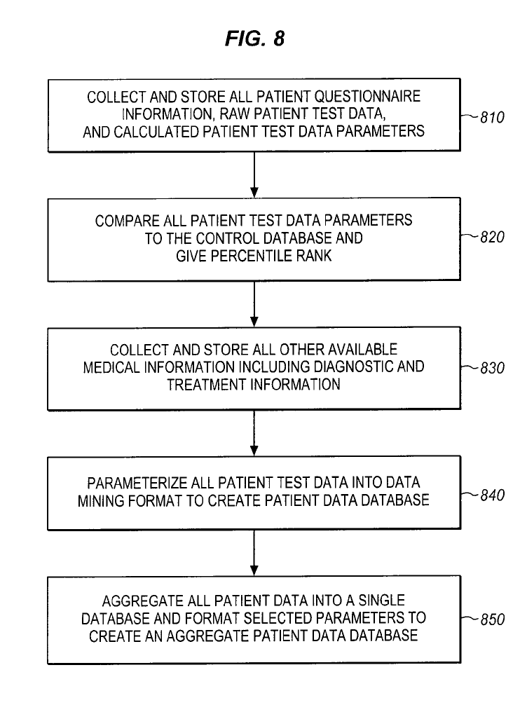

FIG. 8 is a flow chart illustrating a set of operations for generating a patient database which is a subset of data stored in Data Mining Database 280. The patient database includes all available medical information (e.g., inputs from physicians, Electronic Medical Records, raw test data, calculated parameters, and the like).

At step 810, all available patient test data is collected and stored either on a pre-set schedule (e.g., hourly, daily, weekly, etc.), after a predetermined event (e.g., 1000 sets of new patient data are available), or upon a physician request. Once the data is collected, at step 820 all or some of the patient test parameters and/or selected data relations are compared to the control database and generates a percentile rank. Medical information collection operation 830 collects all other available medical information (e.g., from a patient's Electronic Medical Records). Examples of the type of information collected include, but are not limited to, diagnostic and treatment information. Collection operation 830 and patient test data collection operation are combined into a single collection operation. Once all of the data is collected, parameterization operation 840 places the patient test data and medical information into a data mining format to create the patient data database. Placing the data into the data mining format includes using current procedural terminology (CPT) codes from the American Medical Association. Any coding system that accurately describes the medical, surgical, and diagnostic services of a physician may be used. The use of uniform codes, such as the CPT codes, allows for a common condition or treatment to be represented by the same alphanumeric string and makes future correlation and searching easier.

Once parameterization operation 840 is completed, aggregation operation 850 aggregates all the patient data together into a single database. In addition, some or all of the patient test data parameters and functions of patient test data parameters (i.e., data relations) computed in ranking operation 820 are used to generate distributions to create the patient data database.

### Index Creation

Trait Scale Index Creation

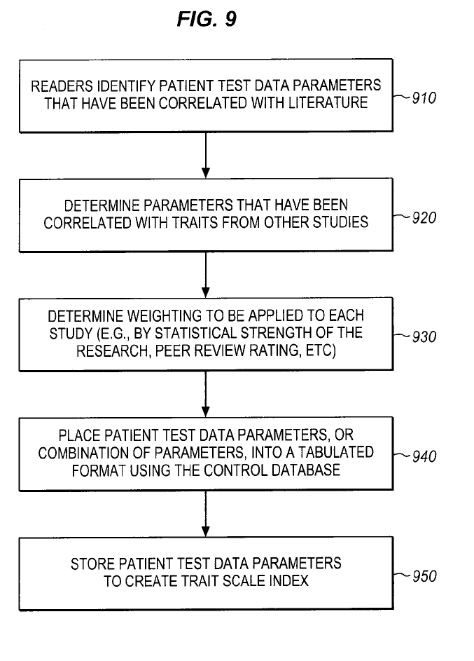

FIG. 9 is a flow chart illustrating a set of operations for generating Trait Scale Index 210. Trait Scale Index 210 is a collection of data relations that have been identified, extracted, and/or created from the literature that has correlated the data relations with psychometric traits (e.g., depression).

Identification operation 910 identifies patient test data parameters and/or data relations that have been correlated with psychometric traits. Identification operation 910 could be performed manually, automatically with the use of a computer (e.g., searching for key words), or through a combination of manual operations and automatic operations. Selection criteria could be used to screen for acceptable articles. A determination is made, in Parameter Collection Operation 920, of the parameters that have been correlated with psychometric traits from other studies that have been published in the literature. Parameter Collection Operation 920 can collect parameters relating to a particular psychometric condition by creating a list of articles addressing the particular psychometric condition and correlated data relations along with other information (e.g., statistical strength of the study). A pattern extraction algorithm can be used to collect the parameters and look for patterns from the literature. The pattern extraction algorithm calculates a trait within the literature and builds a distribution curve from the calculated normative of control data automatically.

In weighting operation 930, a weighting is associated with each study. The weighting can be determined based on the statistical strength of the research, peer review ratings, effectiveness of a certain parameter in predicting the psychometric condition, and others. Not only does weighting operation 930 allow for data relations to be taken directly from literature but also for the creation of new data relations to come up with a better estimator or predictor of the psychometric condition. In some cases, the weight can be generated by performing a best fit on data stored in Data Mining Database 280 which has been associated with the particular psychometric condition.

Distribution operation 940 places the patient test data parameters, or combination of the patient test data parameters, into a curve (typically bell-shaped for normal data) using Control Database 260. These distributions are stored using storing operation 960 to create Trait Scale Index 210. The distributions of the patient test data parameters and/or combination of the parameters are not stored (i.e., only the data relations are stored) in Trait Scale Index 210. In those cases, the distribution can be generated when needed using Control Database 260. The distributions for the data relations then can be stored in Control Database 260 for future access or they can be discarded and generated again as needed.

Diagnostic Index Generation

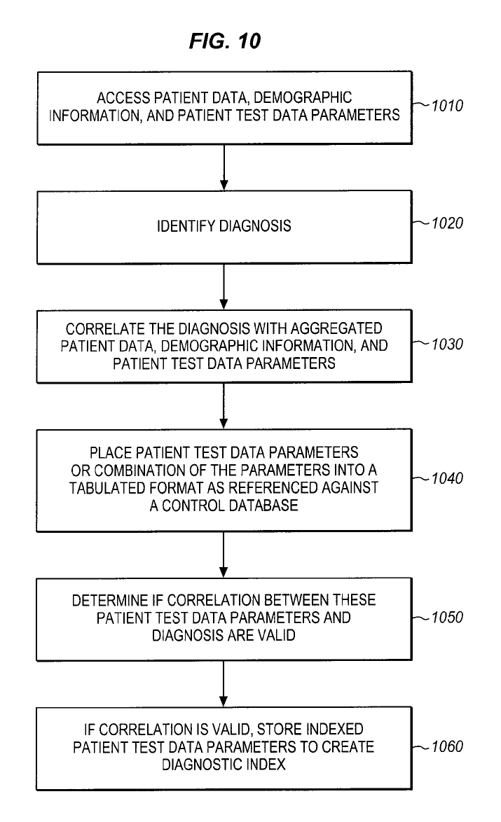

FIG. 10 is a flow chart illustrating a set of operations for generating Diagnostic Index 220. According to various embodiments, Diagnostic Index 220 is a collection of data relations that have been identified, extracted, and/or created from the literature that has correlated the data relations with one or more diagnostic conditions (i.e., ADHD). The resulting Diagnostic Index (stored within a data mart) contains de-identified patient demographic and diagnostic data (and aggregates) for interpreting a given patient's condition.

The Digital Library Access Module 107 accesses patient data at step 1010 from the digitat library data stores that contain a provided diagnostic outcome. These diagnostic indexes are built one diagnosis at a time based upon the availability of patient outcome data (i.e., before constructing these indexes a statistically significant set of measurements must be available). The construction of these diagnostic indexes, in fact, may be based upon the presence of a company sponsored diagnostic research study that provides all the necessary data points to construct this index.

At step 1020, the physician, using a peer-reviewed research study (made with or without the company's product), defines a set of predictive attribution that represents the necessary attributes for supporting the ailment's associated diagnosis. There may be multiple diagnostic indexes for a given ailment, depending on the number of qualifying research studies.

At step 1030, the Data Characterization Module 106 executes a statistical analysis using the provided data sets and attributes based upon patient diagnostic outcome. Multiple analysis techniques are used as is suggested by the supporting research, along with necessary data quality activities to ensure accuracy. Then, at step 1040, the Data Characterization Module 106 implements a Gaussian distribution using the resulting statistical analysis to determine standard variance levels within the given diagnostic index. The input to this diagnostic distribution bell-type curve is also compared against the Control Database 260 for establishing variance levels between the diagnostic and control subject groups.

At step 1050, Data Characterization Module 106 executes statistical quality assurance tests against the Diagnostic Index 220 to ensure the validity of the index. This includes the set of input attributes necessary for accurate matching and confidence levels of the Diagnostic Index 220 conclusions if a patient is missing attribution. At step 1060, upon process approval and statistical validity of the diagnostic index, Data Characterization Module 106 stores the data structure into the system's databases and makes it available to physicians interested in patient point-of-care analysis.

Treatment Index Generation

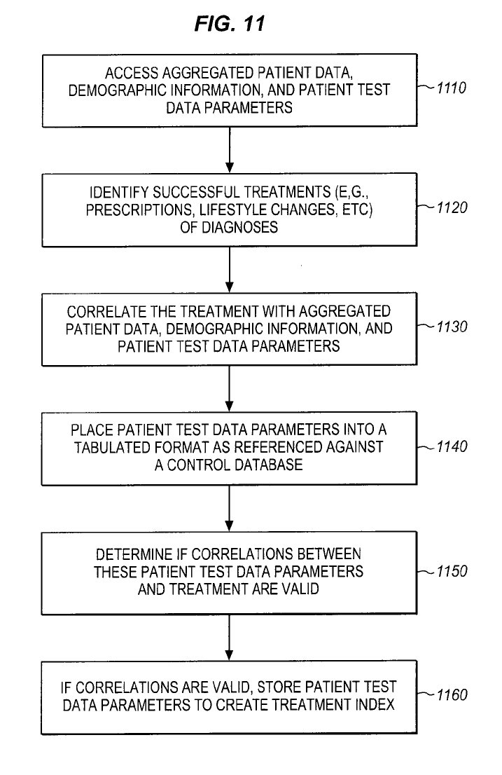

FIG. 11 is a flow chart illustrating a set of operations for generating Treatment Index 230. According to various embodiments, Treatment Index 230 is a collection of data relations that have been identified, extracted, and/or created from the literature that has correlated the data relations with one or more treatment techniques associated with a defined diagnostic pattern. The resulting Treatment Index (stored within a data mart) contains de-identified patient demographic, treatment, and diagnostic data (and aggregates) for interpreting a given patient's treatment options.

At step 1110, the Data Characterization Module 106 accesses patient data from the digital library data stores that contain necessary diagnostic attribution along with corresponding treatment data. These indexes are built based upon treatment types and the corresponding diagnostic markers the treatments are trying to effect. The construction of these treatment indexes use independent or company sponsored treatment and comparative effectiveness research that can be targeted against the company's digital assets.

At step 1120, the physician, using peer-reviewed research studies (made with or without the company's product), establishes a set of treatment attributions that identify the necessary data points for supporting the treatment associated diagnosis. There may be multiple treatment indexes for a given ailment depending on the number of qualifying research studies. Each treatment index is based upon a given research study's conclusion and has established criteria for the identification of successful treatments with respect to prescriptions, lifestyle, or other treatments that correspond to the related diagnostic measurement.

At step 1130, the Data Characterization Module 106 executes a statistical analysis using the provided data sets and attributes based upon a given treatment protocol. Research referenced analysis (i.e., statistical modeling) techniques are used along with necessary data quality activities to ensure accuracy. This includes the correlation of the successful treatment with patient EMR, demographic, and diagnostic device attribution. At step 1140, the Data Characterization Module 106 implements a distribution using the resulting statistical analysis to determine standard variance levels within the given treatment index. The input to this treatment distribution (typically a bell-type curve) is also compared against the Control Database 160 for establishing variance levels between the treatment and control subject groups. The Data Characterization Module 106 at step 1150 executes statistical quality assurance tests against the Treatment Index 230 to ensure the validity of the index. This includes the set of input attributes necessary for accurate matching and confidence levels of the Treatment Index 230 conclusions if a patient is missing attribution.

At step 1160, upon process approval and statistical validity of the treatment index, the Data Characterization Module 106 stores the data structure into the system's databases and makes it available to physicians interested in patient point-of-care analysis.

Predictive Index Generation

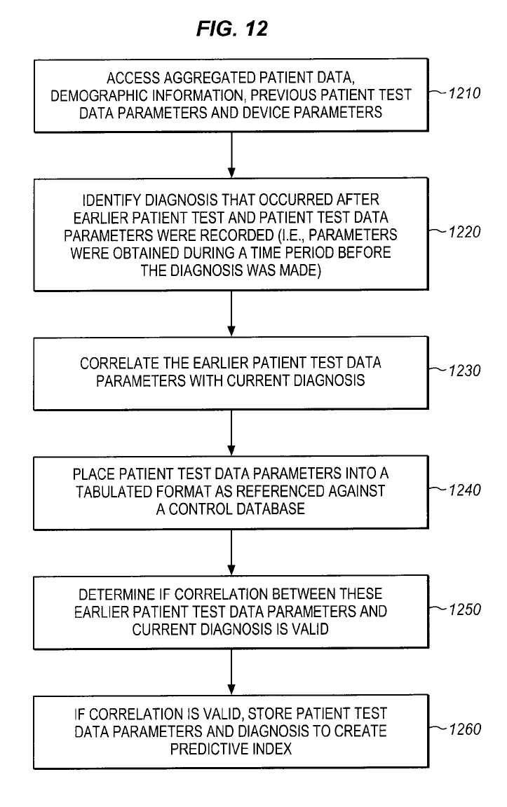

FIG. 12 is a flow chart illustrating a set of operations for generating Predictive Index 240. According to various embodiments, Predictive Index 240 is a collection of data relations that have been identified, extracted, and/or created from the literature that has correlated the data relations with one or more predictive ailment outcomes. The resulting Predictive Index 240 (stored within a data mart) contains de-identified patient demographic, longitudinal, and diagnostic data (and their aggregates) for interpreting a given potential ailment.

At step 1210, the Data Characterization Module 106 accesses patients from the digital library data stores that contain a longitudinal view of the patient's precursor measurements of a subsequently adopted ailment diagnostic marker. This selection process is based upon the identification of quantified and diagnosed patient outcomes that have associated baseline and historical measurements that can be used to show early characteristics of the associated patient outcome. At step 1220, the physician, using peer-reviewed research studies (made with or without the company's product), establishes a set of predictive ailment attributions that identify the necessary data points for supporting the predictive diagnostic outcomes. There may be multiple predictive indexes for a given diagnostic outcome depending on the qualifying research. These indexes may also include co-morbidity conditions that provide the examiner with multiple possible patient outcomes. Each predictive index is based upon a given research study's conclusion and has established criteria for the identification of the precursor patient diagnostic markers.

At step 1220, the Data Characterization Module 106 executes longitudinal analysis that includes the ailment and/or device measurements for pre-symptom and contraction of the research specified outcomes (e.g., pre-, early, and advanced Alzheimer's data points identifying common patterns prior to the final patient outcome). The Data Characterization Module 106 at step 1230 conducts correlation analysis between the pre- and post-measurements and establishes confidence levels by predicted ailment. These correlations are substantiated from the supporting research. In addition, at step 1240, the Data Characterization Module 106 implements a Gaussian distribution using collected data to determine standard variance (std. dev.) levels within the given predictive index. The collected data to this distribution bell-type curve is compared and validated against the Control Database 160.

The Data Characterization Module 106 at step 1250 executes statistical quality assurance tests against the Predictive Index 240 to ensure the validity of the index. This includes confidence levels of the Predictive Index 240 conclusions if a patient is missing attribution. At step 1260, upon process approval and statistical validity of the predictive index, the Data Characterization Module 106 stores the data structure into the system's databases and makes it available to physicians interested in patient point-of-care analysis.

### Populating the Digital Library

Generating Digital Copies of Reference Materials

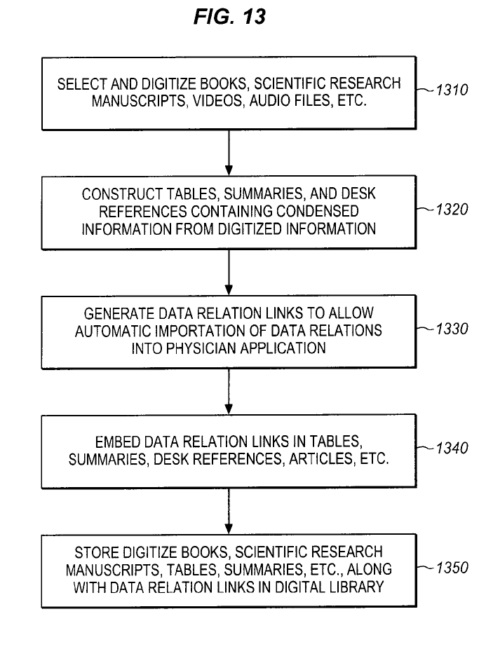

FIG. 13 is a flow chart illustrating a set of operations for generating digital copies of reference materials (Published Literature 250). This process is responsible for integrating multiple media formats into a structure that is used by the invention. Candidate content is segmented by its usage type where semi-automated techniques are used to process and store the new content so it may be accessed by users of the invention.

At step 1310, the operator of the Customized Medical Diagnostic Apparatus 100 selects literature for inclusion into the Digital Library 105 and digitizes these materials. The content selection process is based upon the use of online medical libraries and other peer-reviewed content providers that license content to the invention. The description highlights content (books, articles, research, etc.) specific to the examples used herein; but access to all of the materials in the source library is available to the physician.

At step 1320, a content management process is used to construct tables, summaries, and desk references when available from the candidate content. This process provides multiple entry points for accessing this content as well as the ability to make the content executable in terms of a given patient data set. As part of the content management process, at step 1330, approved incoming content is examined for the presence of structured elements, such as tables, data summaries, and references that provide additional searching and analysis features. The identification of this structured content from the unstructured input content is processed so that they may be more directly and easily accessible by the invention. This includes the referencing of one content element with another through indexing and literature reviews. In addition, at step 1340, for approved content that contains data relations, a process is required to extract the data relationship from the unstructured content and embed across its related content. The Digital Library 105 is the repository for these computable data relationships where they can be reviewed and selected by users of the Customized Medical Diagnostic Apparatus 100. This embedding process also provides for easy selection of this content into the User Interface Setup 310 function. At step 1350, when the candidate content is processed by the above functions, it is formally stored within the Digital Library 105 where it may be accessed by the Physician Application 150 and Analysis Platform 160 components.

Data Mining Operation

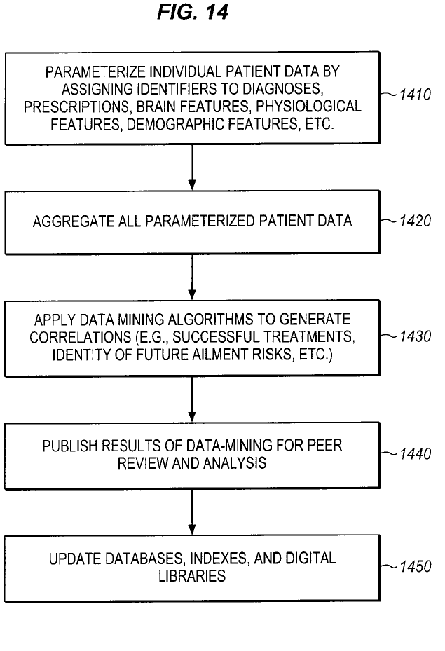

FIG. 14 is a flow chart illustrating a set of operations for updating databases and/or indexes. This represents one example of how the invention improves it's efficacy by leveraging and analyzing one of its key digital assets (i.e., WAVi Data Warehouse). The Data Mining processes are provided to both internal and external researchers for the execution of these data driven techniques against large medical databases. When successful, the analytical conclusions can be published and re-integrated into the invention such that the point-of-care practitioners can quickly benefit from the discoveries.

At step 1410, the process begins with a data quality and review process by which key attribution for the analyses (predictive attributes) are examined for consistency. This includes a data discovery process that looks at frequency distribution of values within given patient data (i.e., the different values entered in the prescriptions field) as well as overall data accuracy and completeness. These data preparation activities are a precursor to each data mining/analysis initiative. At step 1420, based upon the research study definition, data structure aggregations are performed to further analyze the intra- and inter-relationship of the data. These aggregates provide the data statistician with useful ad-hoc access to the data to determine key data relationships as well as providing an optimized set of data structures for analysis.

Once the data structures have been prepared for analysis, at step 1430, specific data mining techniques are employed against the data set. The techniques vary but are generally focused on a classification, estimation, or predictive outcome. Each of these techniques can use different algorithms for accessing different data elements to achieve their predictive results. At step 1440, upon completion of the data analysis and research conclusions, the results are presented for peer review through published journals or other review boards. As part of the review process, both the data and computational techniques are provided for a detailed examination such that full visibility of the employed science is available to both users of the invention as well as scientists and researchers. At step 1450, once approved, the associated data analyses are circulated back into the Customized Medical Diagnostic Apparatus 100 through the information vehicle and content management processes. This Customized Medical Diagnostic Apparatus 100 eco-system ensures new science is continually updated.

### Operation of the Customized Medical Diagnostic Apparatus: EEG Example

EEG Example

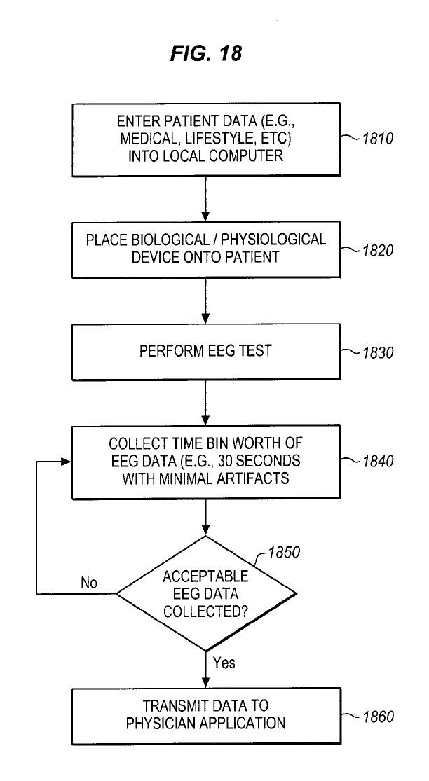

To illustrate the operation of the Customized Medical Diagnostic Apparatus 100, the example of collection and analysis of patient EEG test data is demonstrated below (see FIG. 18). This example is simply illustrative of the operation of the Customized Medical Diagnostic Apparatus 100; and the operation of the system is not limited to use for EEG analysis, but is applicable to all forms of patient data as well as for use in analyzing multiple types of collected patient data to vector in on specific ailments which may be representative of the collected patient data. In particular, at step 1810 in FIG. 18, the patient data is input into the Physician Application 150.

EEG Transducer System

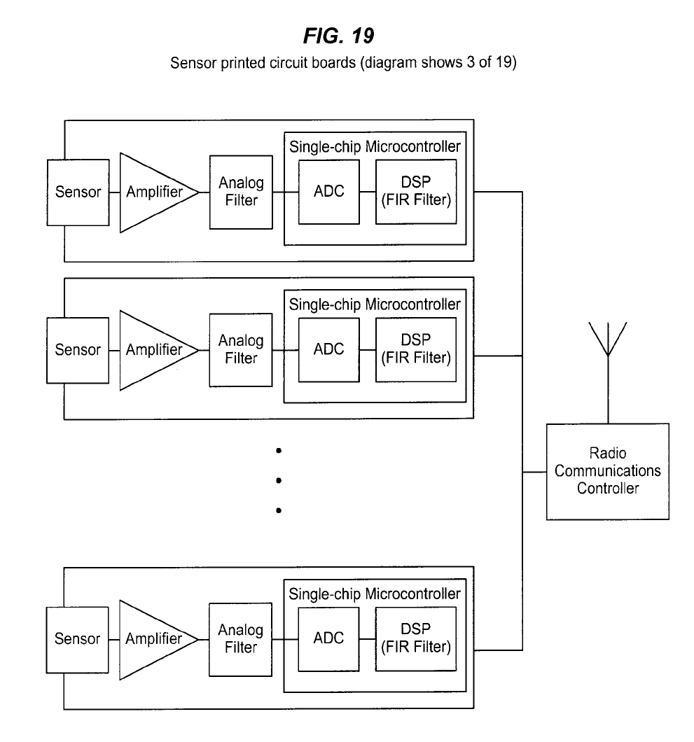

At step 1820, Biological/Physiological Measurement Device 190, as shown in FIG. 3, is placed on the patient. The Biological/Physiological Measurement Device 190 is designed for acquiring device data from a patient at step 1820 and, as shown in FIG. 19, records a plurality of channels of device activity at step 1840 and transfers the data (if determined at step 1850 to be acceptable) at step 1860 to Data Acquisition and Display Module 120 of Physician Application 150 as shown in FIG. 3. Data Acquisition and Display Module 120 is configured to control the Biological/Physiological Measurement Device 190 in acquiring the device data from the patient. For the case of EEG, the electrodes can be selected from or arranged in the International 10-20 EEG Classification System (see FIG. 16), for example. The Biological/Physiological Measurement Device 190 may use a wireless or wire-type transfer system to transfer the data to Display Module 120. Biological/Physiological Measurement Device 190 can include a memory store for temporary storage of device data which is transferred to another device for analysis and/or more permanent storage.

FIG. 16 is a diagram illustrating EEG electrode placement of the Biological/Physiological Measurement Device 190 for gathering EEG data and represents electrode placement consistent with the International 10-20 EEG Classification System. Each electrode site has a letter to identify the lobe and a number or another letter to identify the hemisphere location. The letters C, F, Fp, O, P, and T stand for Central, Frontal, Frontal Pole, Occipital, Parietal, and Temporal locations of the brain, respectively. The even numbers refer to locations in the right hemisphere, the odd numbers refer locations to the left hemisphere, and the letter z refers to an electrode placed on the midline.

The Biological/Physiological Measurement Device 190 can include real-time feedback through smart electrodes which consist of a processor located at each electrode to provide feedback as to other real-time procedures/protocols/additional tests which may be required. Examples are: possible coherence issues in one frequency band is seen—pre-Alzheimer's warning—the electrodes initiate more detailed resolution or more time in that area of the brain. Alternatively, if TBI markers are seen, evoke potential tests can be executed—these tests are brain measurements where EEG is recorded during a task such as watching shapes on a computer screen or listening to sounds or changing posture.

The Biological/Physiological Measurement Device 190 includes a data store for recording EEG data to enable the EEG testing to take place anywhere (e.g., workplace, while riding a bicycle, etc.). The data during the EEG testing then can be transferred for analysis at a later time. The data collected by the sensors can be over sampled to enable a DSP filter to effectively separate the signal from the noise. Over sampling is only performed on the pass-band information and not all of the data. One reason for over sampling only on the pass-band information is that it is not necessary to communicate all of the data but only the data in the pass-band. In traditional applications, in which the DSP filter was performed after the communications, all of the data was over sampled and sent over the communications channel. The use of over sampling reduces the bandwidth requirements of the data link by performing the filtering first and results in a cost savings over traditional systems. Furthermore, this architecture results in processing data with a signal-to-noise ratio that is lower than traditional systems. Consequently, the need for the use of conductive fluid on the sensor can be reduced or even eliminated in some cases.

FIG. 19 is a block diagram illustrating the layout of various components of the Biological/Physiological Measurement Device 190, which includes the analog filters, the chain of amplifiers, the microcontroller, and the DSP filter, all located at the point of the sensor as shown in the figure. The Analog-Digital Converter and the DSP are physically part of the same chip, an inexpensive microcontroller. One advantage of placing the DSP in the sensor assembly is that the data processing task is removed from the computer, simplifying the computer's requirements and, consequently, the cost. Using this topology, the data rate of the digital communications is kept to a minimum.

When the raw EEG data is received from the Biological/Physiological Measurement Device 190, the EEG data then is processed by artifact-removal software to remove artifacts (e.g., electrical signals from muscle movement) to ensure that proper data was collected. Data Acquisition and Display Module 120 can also store the data to be recorded, load previously stored EEG data, and/or display the EEG data in physician-selected formats (e.g., in a raw waveform, a topographic map, a compressed spectral array, etc.). Once the EEG data is processed by Data Acquisition and Display Module 120, the data then is transferred to Physician Application 130. Physician Application 130 may include web-portal application 135 to connect to Analysis Platform 150 and/or to the Customized Medical Diagnostic Apparatus 100.

Physician Application 150 allows the physician to customize displays of EEG data (e.g., spectral, topographical, raw data, etc.), to view only EEG data of interest (e.g., only beta waves from selected channels), and to compare patient EEG data to a demographic-matched reference control database using statistical analysis techniques. A request to process the EEG data is sent to an Analysis Platform which generates the statistical comparison. A data relation setup physician interface screen can also be displayed. The data relation setup physician interface screen allows the physician to select, input, and/or search for data relations to be used in the statistical characterization of the EEG data acquired from helmet 110. The data relations can include functions of EEG data channels and/or extracted EEG features. For example, a physician interested in identifying attention deficit disorder (ADD) could set up a data relation with the ratio of theta/beta at site Cz. As another example, a physician interested in identifying depression could set up a data relation of the difference between FP1 and FP2 voltages. Examples of extracted EEG features include, but are not limited to, the spectral power for each of the EEG frequency bands (i.e., alpha, beta, gamma, theta, and delta) and evoked response potentials. These data relations set up by the physician are computed and statistically compared to reference group data stored in a control database.

In response to receiving sets of EEG data relating to a test subject, a data selection physician interface screen can be displayed that allows for the sets of EEG data to be displayed in a raw data format, a topographic format, a trend analysis format, a spectral power format, a statistical characterization format, and/or the like. The data selection physician interface screen allows the physician to select a desired display format and change between display formats through the use of radio buttons, drop-down menus, or other selection vehicles. In some cases, the data selection physician interface screen allows the physician to select a portion of the data collected which is analyzed and/or displayed. For example, if a large amount of EEG data is collected under a variety of test conditions, the physician could select the portion of the EEG data for analysis that is desired by the physician.

A Digital Library physician interface screen can be generated that presents articles, links to articles, summaries of articles, or other published information retrieved from a Digital Library 105. The Digital Library physician interface screen allows the physician to search Digital Library 105 for data relations relating to particular ailments and/or conditions of interest to the physician. For example, the physician could search for data relations which might indicate Alzheimer's, ADD, depression, or the like when statistically compared to the control EEG data stored in Control Database 260. Once an analysis of the data relations has been performed, the report physician interface screen can be displayed on the terminal. The report physician interface screen could include a predictive ailment report containing a list of potential mental or physical ailments and/or a treatment report containing treatment plans for the list of potential mental or physical ailments in the predictive ailment report. The diagnostic physician interface screen can be displayed on the terminal with input and/or selection areas that allows for a physician to input a diagnosis, the physician's reasoning, and/or prescribed treatment plans.

Once the patient EEG data is collected and the desired data relations are evaluated, along with other pre-set data relations, the EEG data, demographic information, data relation evaluations, and the like are transferred to Data Characterization Module 106 to evaluate a set of critical variables, compare the critical variables to a set of control EEG data stored in a control database, calculate ailment indicators, and display the results to aid a physician in mental assessment. The desired data relations, along with other pre-set data relations, the EEG data, demographic information, data relation evaluations, and the like are used to generate a statistical analysis of the EEG data. Patient EEG data can be analyzed by statistical comparisons to data stored in Control Database 260. Control Database 260 is typically a statistically controlled, age-regressed database in which the data from matching single or multiple EEG channels has been transformed into a Gaussian distribution. EEG data is collected from control individuals and then is stored in the control database in either a raw format and/or as a Gaussian distribution of data relations of channels or features of the EEG data collected.

Patient EEG data also can be analyzed by generating a statistical comparison to data stored in Correlative Database 270 in which EEG features have been correlated with memory functions (e.g., short term memory, concentration, and mental flexibility) or any other psychometrics. Correlative Database 270 is a proprietary collection of EEG data and correlated parameters which have been purchased or developed. In Correlative Database 270, EEG data and psychometric tests results are collected from control individuals. A correlation is made between EEG features collected from the control individuals and the psychometric results.

Data Interpretation

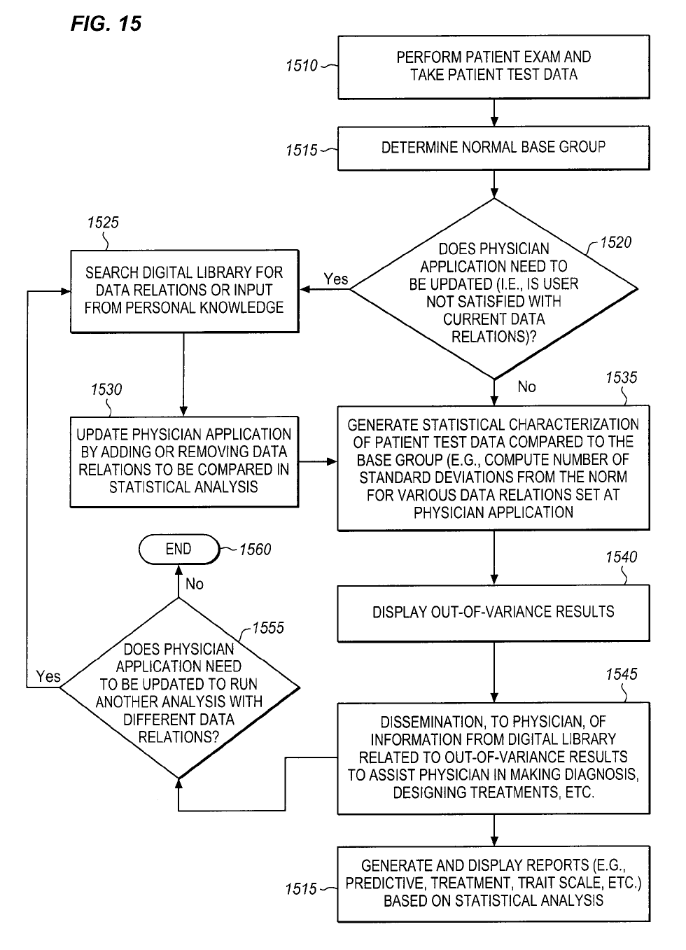

FIG. 15 is a flow chart illustrating an example of a set of operations used to assist in patient test data interpretation. At step 1510, when a patient arrives at a physician's office, the physician can perform a medical exam and make an initial assessment of the patient. Patient data is loaded into the Physician Application interface manually or through accessing an electronic medical record (Electronic Medical Records). Examples of the types of patient information that may be entered include, but are not limited to, historical patient test data from previous collection, medical history, lifestyle information, answers to patient questionnaires, current and/or past medications, demographic information, and the like. Using the available information, the physician determines that the patient may have a certain ailment (e.g., depression). This information collection operation also includes patient test data collection.

The clinician then initiates a patient test to measure selected biological, physiological, and/or psychological characteristics of the patient. The patient test data resulting from the test is either saved for later analysis and/or is directly transferred to the Physician Application station. The pre-set data relations set by the physician are evaluated using the current patient test data. The data relations, patient information, and patient test data then are transmitted to a remote Analysis Platform 160. At step 1515, a control base group is selected from the control database based on the received patient information. The patient information collected can be used in selecting a base group for statistical comparison.

Using the available information from the information collection operation of step 1510, the physician determines if the physician interface needs to be updated so that a statistical analysis can be performed based on data relations which have been correlated to certain ailments the physician is interested in screening. At step 1520, the physician decides whether or not the physician interface needs to be updated to include new data relations or to remove old data relations. If the physician interface needs to be updated, then the process branches to step 1525. If the physician interface does not need to be updated, the process branches to step 1535.

At step 1525, the physician can use personal knowledge about patient test data to setup data relations. In some cases, the physician can supplement his own knowledge by searching the Digital Library 105 for data relations of interest. For example, the physician can search for the ailment of interest (e.g., attention deficit disorder, attention-deficit/hyperactivity disorder (ADHD), depression, obsessive-compulsive disorder, anxiety, schizophrenia, bipolar disorder, and substance abuse) to find published information which include data relations that, when statistically compared to a base group of control subjects, has been shown to indicate the ailment. The published information and indexes stored in Digital Library 105 provide links associated with the data relations that, when selected, automatically load the data relations into Physician Application 150. The physician can load pre-designed data relations that have been developed by experts in the field and begin modifying those if desired. Updating operation 1530 then updates the application physician interface by adding or removing data relations as requested by the physician. The process then branches to step 1535.

In step 1535, once a base group is determined, the desired data relations then are computed for the patient test data; and a statistical characterization is generated by computing the number of standard deviations from the norm of the control group. Differences of the patient data relations from the control activity of the base group are expressed in the form of a z-score for each frequency band. An example is the percentile ranking, or standard score, of the patient's test data as it relates to the performance of control individuals on psychometric tests. At step 1535, the Customized Medical Diagnostic Apparatus 100 also generates a statistical analysis of the patient's test data against correlative databases, predictive databases, and/or indexes to determine the likelihood that the patient has, or will develop, a particular ailment. Once the statistical characterization is complete, these results can be presented to the physician at step 1540 through the Physician Application 130 by links to generated reports, quick reference color-coded scales, numerical percentiles, and/or in other display formats.

At step 1545, the Digital Library Interface Module 107 searches the Digital Library 105 for published information relating to the out-of-variance results determined by the statistical characterization. The results of the search can be displayed through the Physician Application 130. In some cases, the published information (e.g., articles, summaries, etc.) can be used by the physician in making a diagnosis designing treatment options, determining possible related ailments, and/or the like. At step 1550, the Digital Library Interface Module 107 generates and displays reports as directed by the Digital Library Interface Module 107 as customized by the physician. Examples of the types of reports which can be generated include, but are not limited to, a predictive report, a treatment report, and others. The physician can review these reports and/or the disseminated published information displayed at step 1545 to determine if a statistical characterization of the patient's test data needs to be computed using different data relations. At step 1555, the physician decides if the physician interface needs to be updated. If not, then the process branches to step 1560 where the process is concluded. If the physician does decide the physician interface needs to be updated, then the process branches back to step 1525.

FIG. 24 is a screen shot of an example of a physician interface that can be used to help a physician interpret patient test data. As illustrated in FIG. 24, the patient test data can be presented in different formats as selected by the physician. In addition, scales for conditions that are being monitored (e.g., BiPolar, Anxiety, Pre-Dementia, etc.) by the application interface which has been set up by the physician are listed.

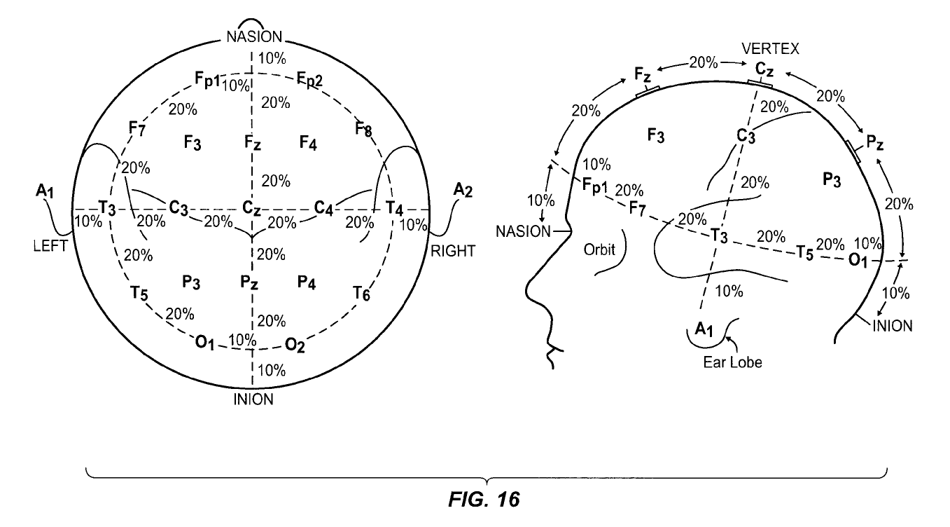

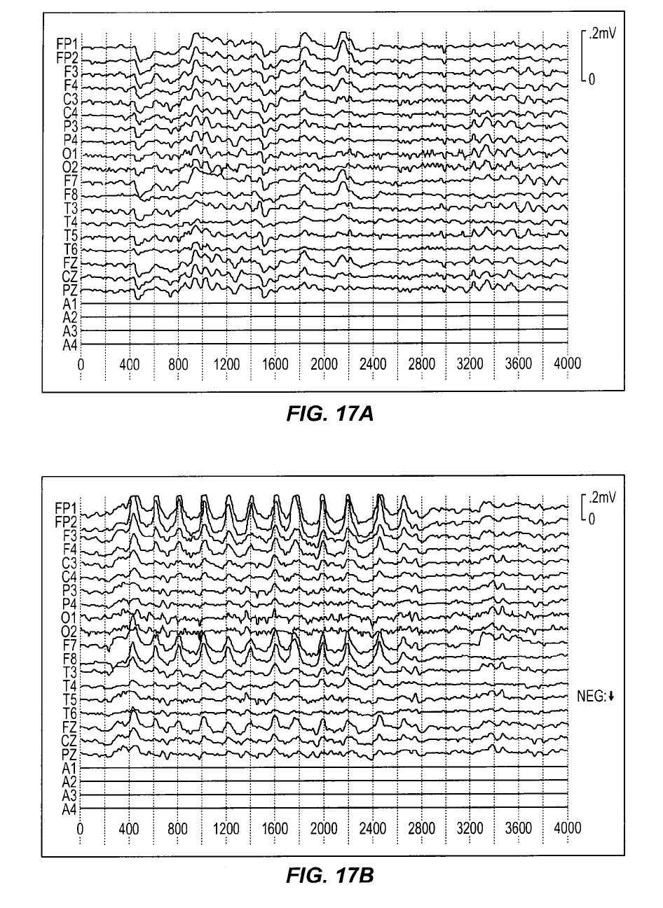

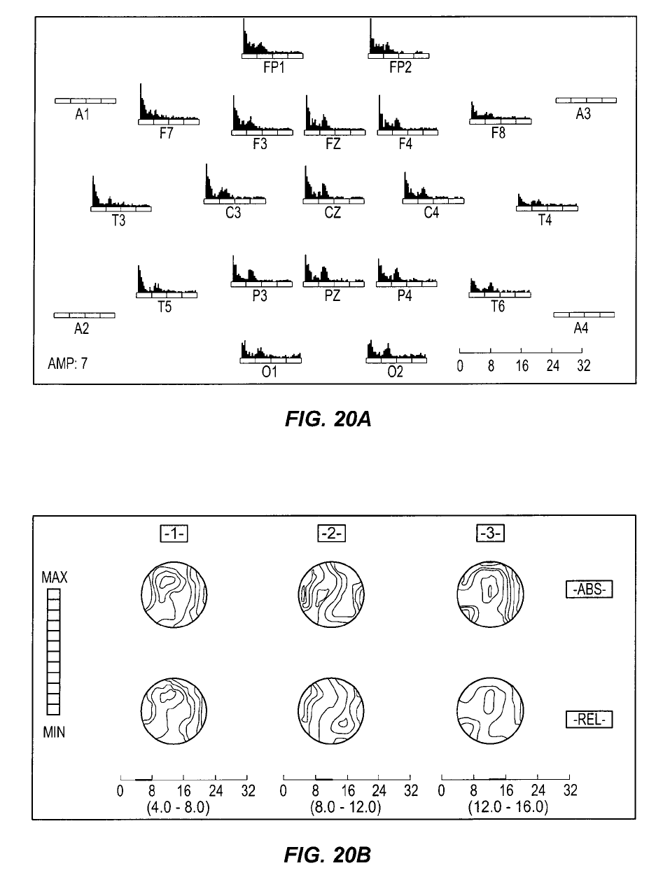

FIGS. 17A and 17B illustrate an example of EEG data that may be gathered during an EEG test. FIG. 20A is a screen shot of patient EEG test data in a spectral array that may be presented. To generate the spectral array shown in FIG. 20A, the raw EEG waves for each electrode are transformed into magnitude or power spectrums. From this type of display, a trained clinician could derive the distribution of power and amplitude (strength) of the brainwaves at each site. FIG. 20B is a screen shot of topographic maps of the raw EEG data that may be presented. As illustrated in FIG. 20B, the topographic maps summarize EEG data by representing power values (i.e., voltage variations) in selected frequencies at selected electrode sites.

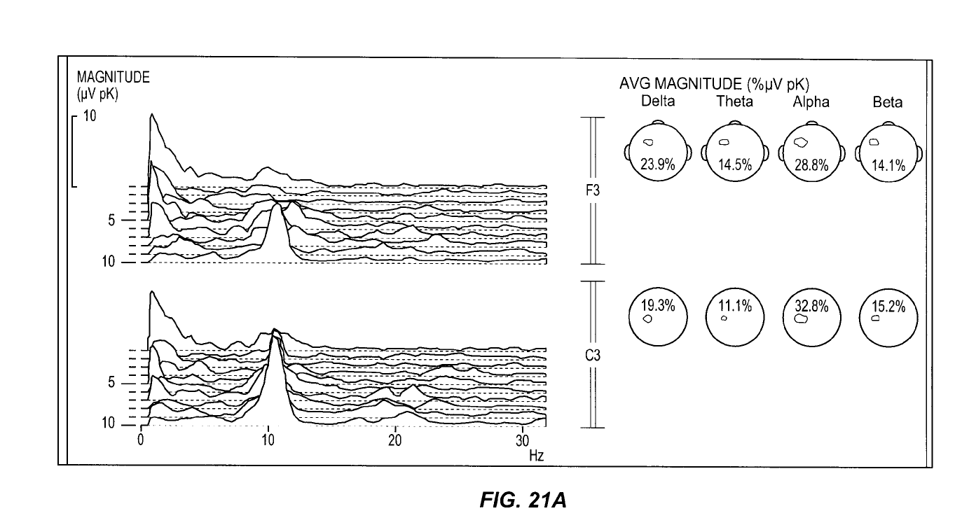

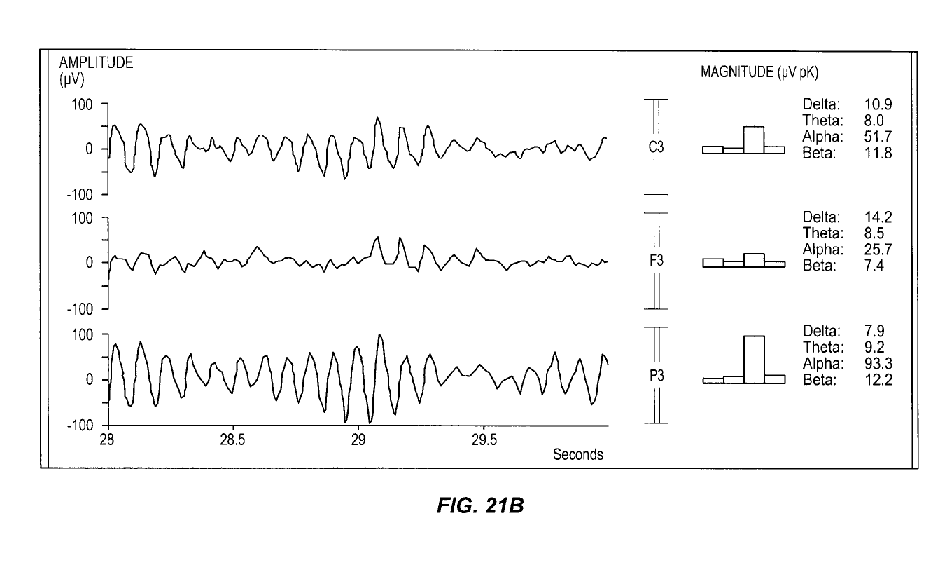

FIG. 21A illustrates a screen shot showing a compressed spectral array of raw EEG data that may be presented. The compressed spectral array illustrates how the spectrum of EEG evolves over time and can be useful for demonstrating certain trends in the data over time which is not observable in many of the other display formats. FIG. 21B illustrates a screen shot of a trend analysis of the raw EEG data that may be presented. Trend analysis of the raw EEG data display is used to display the fluctuations of individual frequency bands over time.

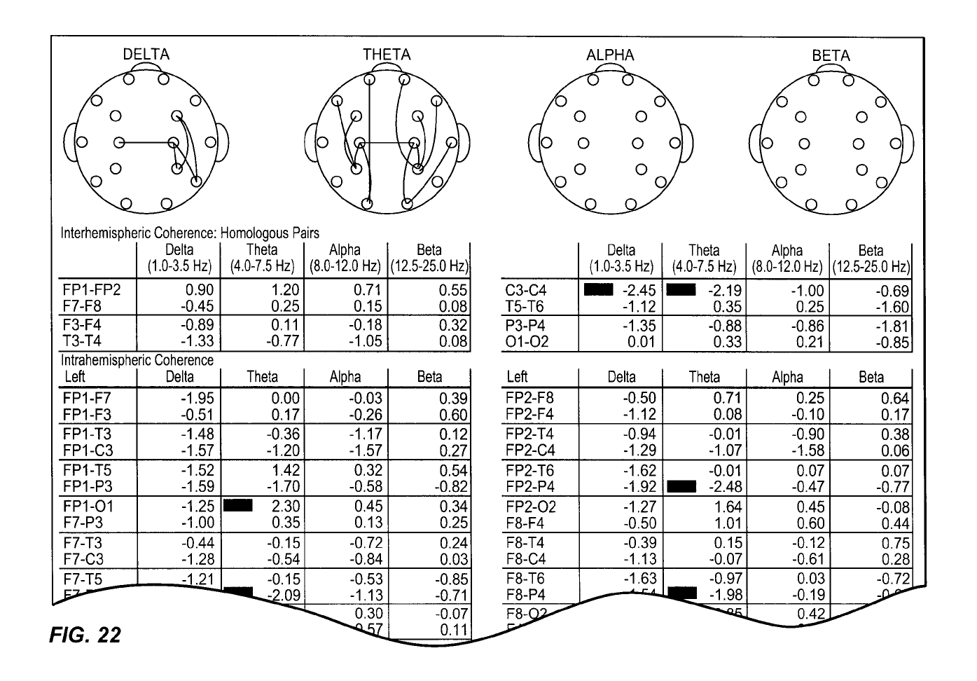

FIG. 22 is an example of a control reference database comparison using coherence z-scores that may be generated. The control reference database comparison shown in FIG. 22 is a frequency-contingent cross-correlation measure indexing the amount of shared activity between two scalp regions. This report is produced by looking for clinician variations from control patient test data from people with similar demographics (e.g., same age group) as the test subject.

Statistical Anatlsis Generation

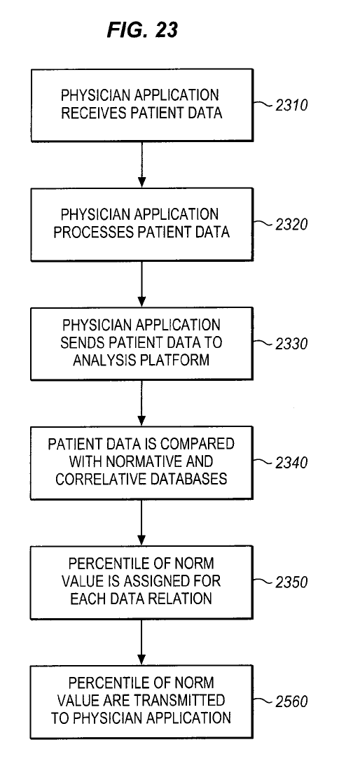

FIG. 23 is a flow chart with a set of operations for generating a statistical analysis. Patient test data is received from a patient at step 2310. Physician Application 150 can process the received patient test data at step 2320 to verify that the received patient test data is of good quality and sufficient length for statistical characterization. At step 2330, the Physician Application 150 transmits the patient test data to the Analysis Platform 160. In some cases, additional information such as patient medical data, data relation formulas, and the like also can be transmitted at step 2330. Additional information can be accessed through electronic medical records (Electronic Medical Records) of the patient. This additional information can be used to determine patient characteristics for determining/selecting the base group for the statistical analysis. In addition, information can be received from a patient's psychological questionnaire that can be used in determining the base group used in the statistical characterization. The patient test data is statistically characterized (e.g., by calculating control variations of the patient test data with test data of a base group) during comparison operation 2340. At step 2350, the Analysis Platform 160 assigns a percentile of control values for each requested data relation. These assigned percentiles then are transmitted back to the Physician Application 150 at step 2360.

Access to articles in the Digital Library 105 based on the statistical characterization of the patient test data can also be provided to the physician. The articles may suggest possible interpretations of the statistical characterization of the patient test data.

Patient Examination

FIG. 26 is a flow chart showing the use of the various indexes in the course of a patient examination. The flow chart starts with the receipt of the biological/physiological device measurement data that is analyzed against the control database and physician customized rule set. Based upon the physician's selections, these analyses can be executed as part of all of the physician's routine examinations, or may be accessed in an ad-hoc fashion for physician-directed analysis.

At step 2610, Data Acquisition Module 120 provides receipt or access to the patient's Biological/Physiological Device 190 measurements. At step 2615, the Data Acquisition Module 120 quantifies the device measurements into units necessary for statistical comparison. This includes the use of predicate mathematical formulas such as Fast Fourier Transforms. The Data Acquisition Module 120, at step 2620, uses the given patient's results and maps them against an approved (FDA cleared) Control Database 260 that provides a set of variances from control to the physician. The specific set of measurements and derivative calculations used in the control comparison are chosen by the physician during the Physician Application setup process. Additionally, this process can push the individual patient values into the digitat library data store where the data is available for updates into the Indices 210, 220, 230, and 240 build processes.

At step 2625, the Data Acquisition Module 120 uses the patient's measurements and attributes as search parameters in the customized physician comparison rules process. As noted, the Physician Application Setup process allows the physician to select what comparisons they want to see across all their patient examinations. These selections are embedded into the physician's customized rule set that references various attributes and data sources including the set of Digital Library indexes (210, 220, 230, and 240). A physician also can manually access each of these functions through an ad-hoc analysis interface.

At step 2630, the trait index comparison takes a given patient's results and maps them against the Trait Scale Index 210 for common attributions and the variance of the patient's results from the control database. At step 2635, the diagnostic index comparison takes a given patient's results and maps them against the diagnostic index for common attribution patterns and the variance of the individual patient's results from the index. The comparison can examine the entire index and all of its respective diagnostic markers or a subset, all of which are selected by the physician. The output is a set of matching diagnostic markers with provided error and confidence levels. At step 2640, the treatment index comparison takes a given patient's results and maps them against the treatment index for common attribution patterns and the variance of the individual patient's results from the index. The comparison can examine the entire index and all of its respective diagnostic markers or a subset, all of which are selected by the physician. The outputs are a set of matching treatment options with provided error and confidence levels. At step 2645, the predictive index comparison takes a given patient's results and maps them against the predictive index for common attribution patterns and the variance of the individual patient's results from the index. The comparison can examine the entire index and all of its respective ailment predictive markers or a subset, all of which are selected by the physician. The outputs are a set of matching predictive ailment markers with provided error and confidence levels.

At step 2650, the Treatment Report Module 330 collects all of the associated analyses and comparisons into a single report. This report contains the results from each of the physician's customized comparison rules for a given patient. These reports are also archived for historical reference. At step 2660, the Treatment Report Module 330 renders the patient results to the physician. This report may exist as hard copy or soft, and provide the statistics associated with each comparison. The online copy of this report provides additional features such as clicking through results to view the detailed calculations, as well as suggested treatment and follow-up actions.

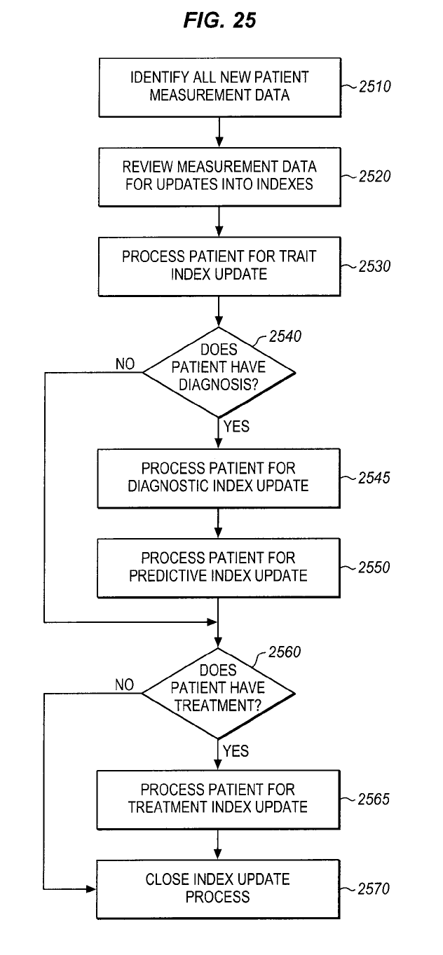

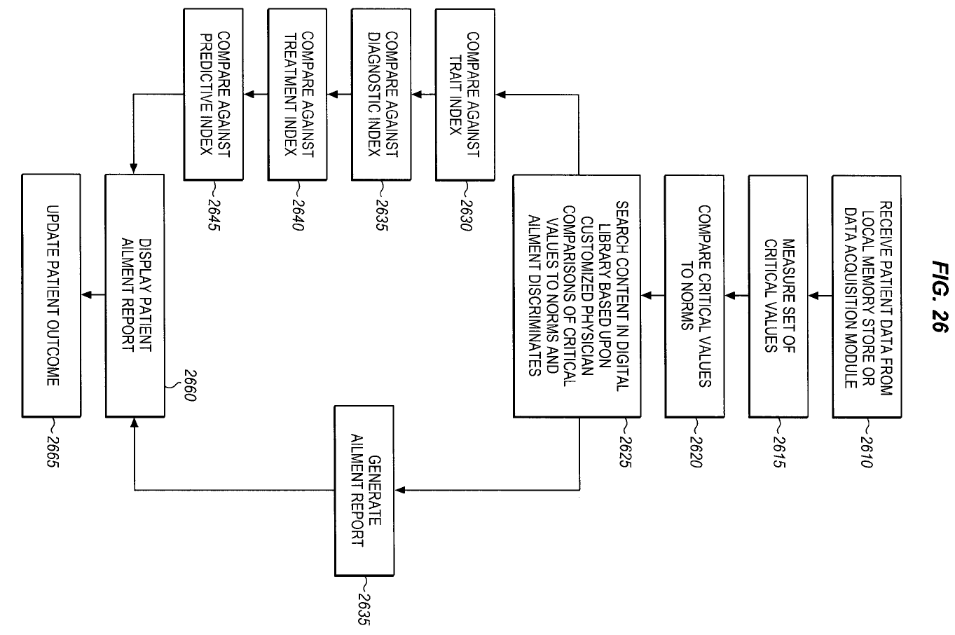

FIG. 25 is a flow chart with an example of a set of operations to update indices. While all patient test data is stored immediately, the updates to these indexes from new incoming patient data are performed via a batch process. At step 2510, the Customized Medical Diagnostic Apparatus 100 tracks all new patient test data by its associated system creation date. As a result, the batch processing system selects all candidate patient index data via this system date criteria. At step 2520, each of these candidate records are selected for processing and evaluated for inclusion to a given ailment and condition index (210, 220, 230, and 240). This establishes if this newly created patient data has enough characteristics to become part of the index.

At step 2530, the trait index process examines the attributes present in the patient record and classifies the record by these basic attributes. These can include: age, handedness, sex, etc., where each of these values may be used as an aggregate key of a new data structure. All new records with basic demographic and patient test data should be included in the trait index. At step 2540, the Customized Medical Diagnostic Apparatus 100 evaluates the candidate record for having all of the necessary attribution for entry into the diagnostic index update logic.

At step 2545, the diagnostic index contains patient data that has at least one patient outcome (diagnosis) provided by a presiding physician. While the diagnosis may change, at least one is required for this process, which also maintains a history of changing diagnostic codes. At step 2550, the predictive index contains both a diagnosis as well as a historical view of the patient prior to the ailment or condition onset. This before-and-after view represents the key elements of the predictive index. The index update process must also account for changing diagnostics as well as additional statistical error and confidence rates.

At step 2560, the Customized Medical Diagnostic Apparatus 100 looks to the patient data for accurate and complete treatment data necessary for updating the Treatment Index 230. At step 2565, the Treatment Index 230 contains patient data that has at least one patient outcome (diagnosis) and at least one treatment iteration provided by a presiding physician. While the treatment may change, at least one prescribed treatment with surrounding patient measurements is necessary for this process.

At step 2570, the batch process completes with a data quality check of all updated indexes which is followed by a rename and replace process that makes the indexes instantly available once all data validation is complete. This also prevents users from examining an index during updates.

What is claimed as new and desired to be protected by Letters Patent of the United States is:

1. A physician operated medical data analysis system for assisting a physician in identifying ailments and conditions which correlate to anomalies identified in a set of patient medical data relating to an identified patient, comprising:
a Digital Library for providing access to a plurality of published literature which relate to interpreting patient medical data and possible ailments associated with patient medical data;
a control database which contains a plurality of sets of medical data indicative of measurements indicative of characteristics of control subjects;
a data characterization module for calculating control variations of a set of patient medical data, collected from and about an identified patient, from at least one of said plurality of sets of medical data in said control database to identify anomalies in said set of patient medical data;
a characterization module relating to said set of patient medical data for searching the Digital Library for published literature relating to at least one of the set of patient medical data and interpretations of the identified anomalies calculated by said data characterization module; and
an information access module for providing an authorized physician with access to physician selected published literature identified by the characterization module.

2. The medical data analysis system of claim 1 wherein said data characterization module calculates control variations using at least one data relations process selected by said physician.

3. The medical data analysis system of claim 1, further comprising:
data relations search process, responsive to a physician identified ailment, for identifying published literature in said Digital Library which identifies data relations processes associated with said physician identified ailment.

4. The medical data analysis system of claim 1 wherein said data characterization module comprises:
a statistical analyzer for comparing said set of patient medical data to a set of physician selected demographic-matched reference control data.

5. The medical data analysis system of claim 4 wherein said data characterization module further comprises:
an ailment identifier for generating data which identifies at least one ailment that corresponds to a variation of said set of patient data from said physician selected demographic-matched reference control data.

6. The medical data analysis system of claim 5 wherein said data characterization module further comprises:
an ailment correlator for identifying published literature relating to said identified ailments.

7. The medical data analysis system of claim 4 wherein said data characterization module further comprises:
an ailment filter, responsive to data received from said physician indicative of at least one known ailment, for activating said statistical analyzer to select demographic-matched reference control data relating to said at least one known ailment.

8. The medical data analysis system of claim 3 wherein said data characterization module comprises:
a predictive analyzer, responsive to said set of patient medical data, for using at least one of correlative databases, predictive databases, and trait indices to generate an estimation of a likelihood that said identified patient will develop particular ailments.

9. The medical data analysis system of claim 8 wherein said characterization module comprises:
an ailment correlator, responsive to said predictive analyzer generating an estimation of a likelihood that said identified patient will develop particular ailments, for identifying published literature relating to said particular ailments.

10. The medical data analysis system of claim 1 wherein said information access module comprises:
a security module for authenticating an identity of said physician; and
an authorization module for determining that said authenticated physician has authorization to access any of said set of patient medical data and said published literature relating to said patient.

11. The medical data analysis system of claim 1 wherein said Digital Library comprises:
a plurality of published literature, each of which relates to interpreting medical data and possible ailments associated with medical data.

12. The medical data analysis system of claim 1, further comprising:
a secure memory for storing a set of patient medical data collected from and about an identified patient for use by authorized accessing physicians.

13. The medical data analysis system of claim 1 wherein said set of patient medical data comprises:
monitoring data collected from medical devices operable to measure physiological data relating to said identified patient.

14. A method of operating a physician directed medical data analysis system for assisting a physician in identifying ailments and conditions which correlate to anomalies identified in a set of patient medical data relating to an identified patient, comprising:
providing access to a Digital Library which contains a plurality of published literature which relate to interpreting patient medical data and possible ailments associated with patient medical data;
calculating control variations of a set of patient medical data collected from and about an identified patient with patient medical data of a base set of control data to identify anomalies in said set of patient medical data;
searching the Digital Library for published literature relating to at least one of the set of patient medical data and interpretations of the identified anomalies calculated by said step of calculating control variations; and
providing information access to an authorized physician with access to the published literature identified by the step of searching the Digital Library.

15. The method of operating a medical data analysis system of claim 14 wherein said step of calculating determines control variations using at least one data relations process selected by said physician.

16. The method of operating a medical data analysis system of claim 14, further comprising:
identifying, in response to a physician identified ailment, published literature in said Digital Library which identify data relations processes associated with said physician identified ailment.

17. The method of operating a medical data analysis system of claim 14 wherein said step of calculating control variations comprises:
comparing, via a statistical analyzer, said set of patient medical data to a set of physician selected demographic-matched reference control data.

18. The method of operating a medical data analysis system of claim 17 wherein said step of calculating control variations further comprises:
generating data which identifies at least one ailment that corresponds to a variation of said set of patient data from said demographic-matched reference control data.

19. The method of operating a medical data analysis system of claim 18 wherein said step of calculating control variations further comprises:
identifying published literature relating to said identified ailments.

20. The method of operating a medical data analysis system of claim 17 wherein said step of calculating control variations further comprises:
activating, in response to data received from a physician indicative of at least one known ailment, said statistical analyzer to select demographic-matched reference control data relating to said at least one known ailment.

21. The method of operating a medical data analysis system of claim 17 wherein said step of calculating control variations comprises:
using, in response to said set of patient medical data, at least one of correlative databases, predictive databases, and trait indices to generate an estimation of a likelihood that said identified patient will develop particular ailments.

22. The method of operating a medical data analysis system of claim 21 wherein said step of searching a Digital Library comprises:
identifying, in response to said predictive analyzer generating an estimation of a likelihood that said identified patient will develop particular ailments, published literature relating to said particular ailments.

23. The method of operating a medical data analysis system of claim 14 wherein said step of providing information access comprises:
authenticating an identity of said physician; and
determining that said authenticated physician has authorization to access any of said set of patient medical data and said published literature relating to said patient.

24. The method of operating a medical data analysis system of claim 14, further comprising:
storing in a secure memory a set of patient medical data collected from and about an identified patient for use by authorized accessing physicians.

25. The method of operating a medical data analysis system of claim 14 wherein said set of patient medical data comprises:
monitoring data collected from medical devices operable to measure physiological data relating to said identified patient.

26. The method of operating a medical data analysis system of claim 14 wherein said step of providing access to Digital Library comprises:
electronically storing a plurality of published literature, each of which relates to interpreting medical data and possible ailments associated with medical data.
